(19) United States
(12) Patent Application Publication
(10) Pub. No.: US 2024/0238740 A1
(43) Pub. Date: Jul. 18, 2024

(54) MIXER, AIR CAP, AND MIX CHAMBER ASSEMBLY FOR A PLURAL COMPONENT SPRAYER

(71) Applicant: Graco Minnesota Inc., Minneapolis, MN (US)

(72) Inventors: Joseph E. Tix, Hastings, MN (US); Christopher J. Pellin, Victoria, MN (US); John R. Ingebrand, New Prague, MN (US); Jeremy R. Plough, Minnetonka, MN (US); Kyle A. Bottke, Plymouth, MN (US)

(21) Appl. No.: 18/289,471

(22) PCT Filed: May 19, 2022
(86) PCT No.: PCT/US22/30074

§ 371 Date: Nov. 3, 2023

Related U.S. Application Data
(60) Provisional application No. 63/249,921, filed on Sep. 29, 2021.
(60) Provisional application No. 63/190,788, filed on May 20, 2021.

(51) Int. Cl. B01F 25/23; B01F 33/501; B01F 35/30; B05B 7/04

(52) U.S. Cl. CPC B01F 25/23; B01F 33/50114; B05B 7/0408; B01F 2035/351

(57) ABSTRACT

A mixer (46) for a plural component sprayer is configured to receive first and second component materials and emit a spray of a resulting plural component material. The mixer includes a contoured seal head (120) that is configured to interface with a contoured chamber within a receiver to form a fluid-tight seal therebetween. The mixer receives individual component materials through inlet bores (50a, 50b) formed through the mixer. The component materials mix within a mix bore (52) of the mixer to form a plural component material that is emitted as a spray from an orifice (54) formed in the mixer.

### CROSS-REFERENCE TO RELATED APPLICATION(S)

This application claims priority to U.S. Provisional Application No. 63/190,788 filed May 20, 2021 and entitled “MIXING AND SPRAYING ELEMENT,” and claims priority to U.S. Provisional Application No. 63/249,921 filed Sep. 29, 2021 and entitled “MIXER AND MIX CHAMBER ASSEMBLY FOR A PLURAL COMPONENT SPRAYER,” the disclosures of which are hereby incorporated by reference in their entireties.

### BACKGROUND

This disclosure is related to sprayers. More particularly, this disclosure is related to plural component sprayers.

Plural component sprayers receive multiple component materials and combine the multiple component materials to form a plural component material. For example, the plural component material can form an insulator, such as foam, paint, sealant, coating, adhesive, etc. Some examples of plural component sprayers receive catalysts, such as isocyanate, and resin, such as polyol resin, which combine to form a spray foam. Spray foam insulation can be applied to substrates to provide thermal insulation. The spray gun is triggered to open a pathway out of the gun and eject the plural component material. The spray gun includes a mix chamber within which the individual component materials mix to form the plural component material and from which the resultant plural component material is emitted as the spray. Different mix chambers having differently sized bores and flowpaths therethrough can be used to apply the plural component material for different applications, such as smaller bores for final detail work and larger bores for coarser detail work. Maintenance of a plural component sprayer or swapping of mix chambers requires disassembly of the entire fluid head for service, maintenance, and to address any issues that may have caused a failure to spray.

### SUMMARY

According to an aspect of the disclosure, a mixer configured for a plural component sprayer includes a mix chamber body; a mix bore extending along an axis through the mix chamber body, wherein an outlet orifice is formed at a distal end of the mix bore; a first inlet bore extending through the mix chamber body to the mix bore; a second inlet bore extending through the mix chamber body to the mix bore; a retaining head disposed at a first axial end of the mixer, the mix bore extending through the retaining head; and a seal head disposed at a second axial end of the mixer opposite the first axial end, wherein the seal head has an exterior surface that converges towards the axis.

According to an additional or alternative aspect of the disclosure, a mix chamber assembly for use in a plural component sprayer includes an air cap having a central opening therethrough and a mixer mounted to the air cap and at least partially disposed within the central opening. The mixer includes a mix chamber body; a mix bore extending along an axis through the mix chamber body, wherein an outlet orifice is formed at a distal end of the mix bore; a first inlet bore extending through the mix chamber body to the mix bore; and a second inlet bore extending through the mix chamber body to the mix bore.

According to another additional or alternative aspect of the present disclosure, an air cap configured for use in a plural component sprayer includes a cap body disposed about a cap axis, the cap body having a first axial side facing in a first axial direction along the cap axis and a second axial side facing in a second axial direction along the cap axis; a mount extending in the second axial direction from the second axial side, the mount including first threading formed on one of an exterior radial surface of the mount and on an interior radial surface of the mount; and a cap bore extending through the air cap between the first axial side and the retainer face of the mount.

According to another additional or alternative aspect of the present disclosure, an air cap configured for use in a plural component sprayer includes a cap body disposed about a cap axis, the cap body having a first axial side facing in a first axial direction along the cap axis and a second axial side facing in a second axial direction along the cap axis; a mount connected to the cap body and including a cap end at least partially disposed within the cap body and a mount end projecting axially outward from the second axial side of the cap body; and a cap bore extending through the air cap between the first axial side and the retainer face of the mount.

According to another additional or alternative aspect of the present disclosure, a mixer configured to receive individual component materials that chemically interact to form a plural component material for spraying by a plural component sprayer includes a mix chamber body; a retaining head spaced from a first axial end of the mix chamber body such that an axial receiver is formed between the retaining head and the mix chamber body; a seal head disposed at a second axial end of the mix chamber body opposite the first axial end, wherein the seal head has an exterior surface that converges towards the axis; a first inlet bore extending through the mix chamber body to the mix bore; a second inlet bore extending through the mix chamber body to the mix bore; and an outlet orifice formed at a distal end of a mix bore, the mix bore extending along an axis through the mix chamber body, the mix bore intersecting with the first inlet bore and the second inlet bore, and the mix bore extending through the retaining head.

According to another additional or alternative aspect of the present disclosure, a mixer configured to receive individual component materials that chemically interact to form a plural component material for spraying by a plural component sprayer includes a mix chamber body extending between a first axial end and a second axial end opposite the first axial end; a seal head disposed at the second axial end of the mix chamber body, wherein the seal head has an exterior surface; a first inlet bore extending through the seal head to the mix bore; a second inlet bore extending through the seal head to the mix bore; and an outlet orifice formed at a distal end of a mix bore, the mix bore extending along an axis through the mix chamber body, the mix bore intersecting with the first inlet bore and the second inlet bore, and the mix bore extending through the retaining head.

According to another additional or alternative aspect of the present disclosure, a method including aligning a mixer of a mix chamber assembly with a receiving chamber of a plural component sprayer along an axis, the mix chamber assembly further including an air cap connected to the mixer; shifting the mix chamber assembly in a first axial direction such that the mixer enters into the receiving chamber; and engaging a locking interface between the mix chamber assembly and the plural component sprayer to secure the mix chamber assembly to the plural component sprayer.

According to yet another additional or alternative aspect of the disclosure, a method of modifying a plural component sprayer includes manipulating a first air cap of a first mix chamber assembly to disengage a locking interface between the first air cap and the plural component sprayer; pulling the first air cap in a first axial direction along a spray axis of the plural component sprayer such that the first air cap engages a first mixer of the first mix chamber assembly and pulls the first mixer in the first axial direction and out from a receiving chamber of the plural component sprayer; aligning a second mix chamber assembly with the receiving chamber along the spray axis; shifting the second mix chamber assembly in a second axial direction opposite the first axial direction such that a second mixer of the second mix chamber assembly enters into the receiving chamber; and manipulating a second air cap of the second mix chamber assembly to engage a locking interface between the second air cap and the plural component sprayer.

According to yet another additional or alternative aspect of the disclosure, a mixer configured for a plural component sprayer includes a mix chamber body; a mix bore extending along an axis through the mix chamber body, wherein an outlet orifice is formed at a distal end of the mix bore; a seal head disposed at a second axial end of the mixer opposite the first axial end, wherein the seal head has an exterior surface that converges towards the axis; a first inlet bore extending through the seal head to the mix bore; and a second inlet bore extending through the seal head to the mix bore.

According to yet another additional or alternative aspect of the disclosure, a plural component sprayer configured to receive individual component materials that chemically interact to form a plural component material for spraying by the plural component sprayer, the plural component sprayer includes a receiver disposed within a body of the plural component sprayer; a mixer at least partially disposed within the receiver, the mixer including a mix bore extending along an axis, a first inlet bore extending from an exterior of the mixer to the mix bore to provide a first individual component material to the mix bore, a second inlet bore extending from the exterior of the mixer to the mix bore to provide a second individual component material to the mix bore, and a spray orifice formed at an end of the mix bore and configured to emit the plural component material; and an air cap interfacing with the mixer to bias the mixer into the receiver.

### BRIEF DESCRIPTION OF THE DRAWINGS

FIG. 1A is an isometric view of a plural component sprayer.

FIG. 1B is a cross-sectional view of the sprayer taken along line B-B in FIG. 1A.

FIG. 1C is an enlarged view of detail C in FIG. 1B.

FIG. 2A is a first isometric view of a mix chamber assembly.

FIG. 2B is a second isometric view of the mix chamber assembly shown in FIG. 2A.

FIG. 2C is a first isometric cross-sectional view of the mix chamber assembly taken along line C-C in FIG. 2A.

FIG. 2D is a second isometric cross-sectional view of the mix chamber assembly taken along line D-D in FIG. 2A.

FIG. 3A is a first isometric view of a receiver portion of a spray control assembly.

FIG. 3B is a cross-sectional view taken along line B-B in FIG. 3A.

FIG. 3C is an isometric end view of the receiver portion shown in FIG. 3A.

FIG. 4A is an isometric view of a spray control assembly.

FIG. 4B is a cross-sectional view taken along line B-B in FIG. 4A.

FIG. 4C is a cross-sectional view taken along line C-C in FIG. 4A.

FIG. 5A is an isometric exploded view of a spray control assembly.

FIG. 5B is a cross-sectional view of a spray control assembly taken along line B-B in FIG. 5C.

FIG. 5C is a cross-sectional view of a spray control assembly taken along line C-C in FIG. 5B.

FIG. 6A is an isometric view of a plural component sprayer.

FIG. 6B is a cross-sectional view of the plural component sprayer of FIG. 6A taken along line B-B in FIG. 6A.

FIG. 7 is an isometric view of a mix chamber assembly.

FIG. 8 is an isometric view of a head cover for a plural component sprayer.

FIG. 9 is an enlarged cross-sectional view showing a mixer mounted within a receiving chamber of a receiver.

FIG. 10A is a first isometric view of a mixer.

FIG. 10B is a second isometric view of the mix chamber shown in FIG. 10A.

FIG. 11A is a first plan view of a mixer.

FIG. 11B is a second plan view of the mixer of FIG. 11A.

FIG. 11C is an enlarged isometric view showing a seal head of the mixer shown in FIG. 11A.

FIG. 12 is a cross-sectional view of a spray control assembly.

FIG. 13A is a first isometric view showing a mix assembly.

FIG. 13B is a second isometric view of the mix assembly shown in FIG. 13A.

FIG. 13C is a cross-sectional view taken along line C-C in FIG. 13A.

### DETAILED DESCRIPTION

This disclosure is directed to sprayers, particularly plural component sprayers. More particularly, this disclosure is related to mixers within which individual component materials are combined to form a plural component material. The mixer can be mounted to and removed from the plural component sprayer as a discrete component. In some examples, the mixer, which can also be referred to as a mix chamber, can be integrated into a quick-connect mix chamber assembly that is mountable to and dismountable from the plural component sprayer without requiring manipulation of other components of the sprayer.

The disclosure is related to air caps that can connect and/or support mixers on a plural component sprayer. The air cap can include first components, the first components configured to interface with the mixer to connect the mixer to the air cap, and second components, the second components configured to interface with the sprayer to secure the air cap to the sprayer. The air cap can be formed from multiple components that provide support and flexibility to the air cap during mounting on a sprayer and dismounting from the sprayer. More resilient portions of the air cap can interface with the mixer and sprayer and can support less resilient portions of the air cap.

The mix chamber assembly is accessible from outside of the plural component sprayer and can be manipulated to unlock and remove the mixer or to lock the mixer to the plural component sprayer for spraying. The mix chamber assembly self-aligns the mixer with feed bores within the plural component sprayer that provide the individual component materials to the mixer for mixing. The quick-connect mix chamber assembly facilitates quick and easy installation, removal, replacement, and servicing of the mixer of the plural component sprayer.

A first mix chamber assembly having a mixer with a first configuration can be quickly and easily removed and then serviced and/or replaced with a mixer of the same configuration or a mixer having a second, different configuration. For example, mixers having differently sized spray orifices can be quickly swapped to facilitate spraying for finer detail and coarser detail work. The quick-connect mix chamber assembly facilitates quick and easy reconfiguring of a plural component sprayer to generate different patterns and to spray materials of different compositions and/or to spray at different pressures.

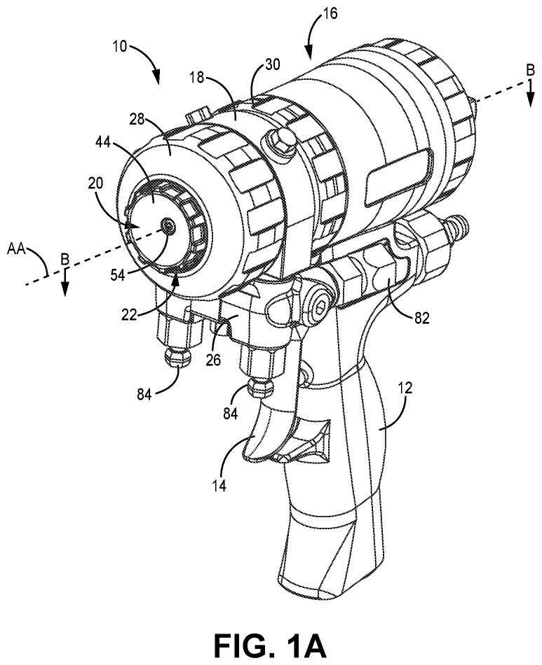

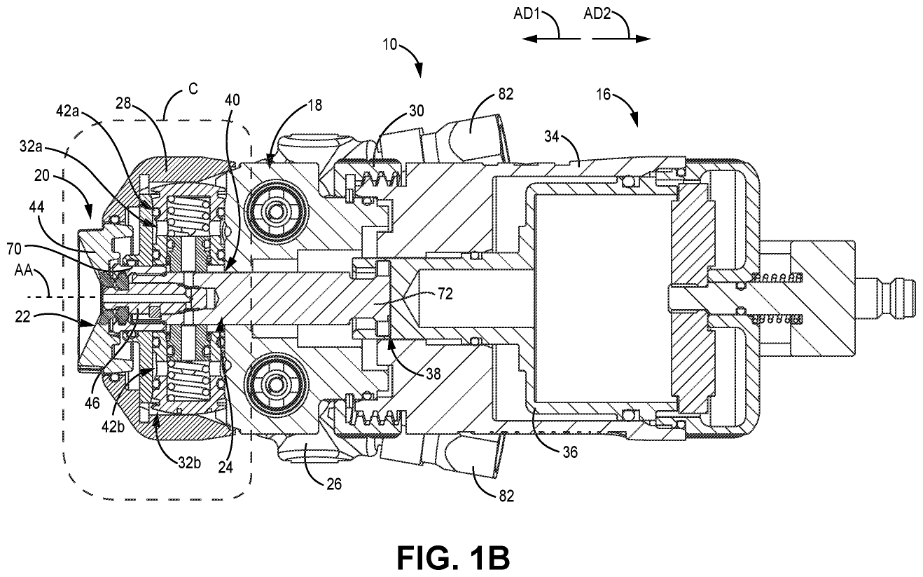

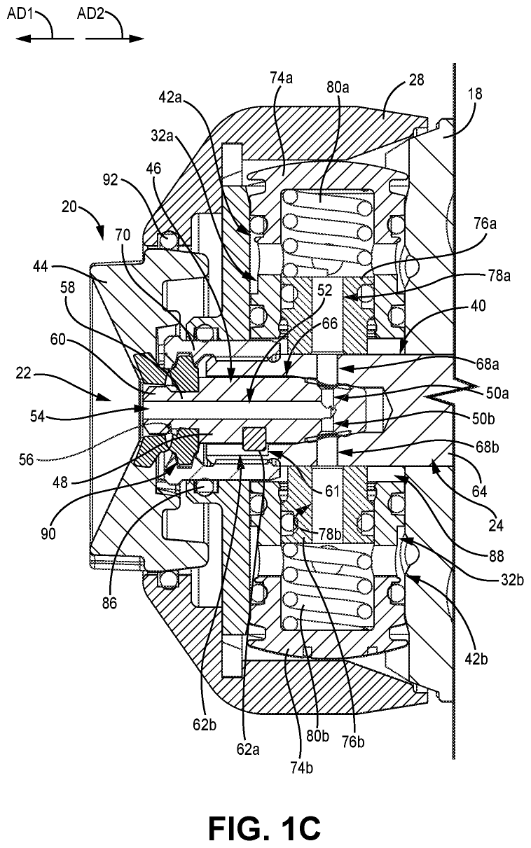

FIG. 1A is an isometric view of plural component sprayer 10. FIG. 1B is a cross-sectional view of plural component sprayer 10 taken along line B-B in FIG. 1A. FIG. 1C is an enlarged view of detail C in FIG. 1B. FIGS. 1A-1C will be discussed together. Plural component sprayer 10 includes handle 12; trigger 14; actuator 16; mounting head 18; spray control assembly 20; mix chamber assembly 22; receiver 24; inlet manifold 26; retaining cap 28; and seal assemblies 32a, 32b. Actuator 16 includes cylinder 34 and piston 36. Piston 36 includes tab lock 38. Mounting head 18 includes central aperture 40 and material feed apertures 42a, 42b. Mix chamber assembly 22 and receiver 24 form spray control assembly 20. Mix chamber assembly 22 includes air cap 44 and mixer 46. Mixer 46 includes mix chamber body 48; inlet bores 50a, 50b; mix bore 52; orifice 54; annular recess 56; neck 58; retaining head 60; and rotation lock 62a. Receiver 24 includes mount body 64; receiving chamber 66; feed bores 68a, 68b; cap retainer 70; and tail 72. Seal assembly 32a includes seal body 74a, seal member 76a defining material flowpath 78a, and spring 80a. Seal assembly 32b includes seal body 74b, seal member 76b defining material flowpath 78b, and spring 80b.

Plural component sprayer 10 is configured to receive and mix multiple component materials to form a plural component material for application on a substrate. The individual component materials are driven to plural component sprayer 10 by upstream pressure sources, such as pumps. The upstream pressures drive the component materials to mixer 46 to form the plural component material that is then ejected as a spray from plural component sprayer 10. For example, plural component sprayer 10 can receive a first component material, such as a resin (e.g., polyol resin), and a second component material, such as a catalyst (e.g., isocyanate), that combine to form a spray foam. The spray foam is emitted from plural component sprayer 10 as a spray and applied to a substrate. It is understood, however, that plural component sprayer 10 can be configured to generate and emit any desired plural component material, such as foam, paint, sealant, coating, adhesive, etc.

Handle 12 is configured to be grasped by the hand of a user. Trigger 14 is pivotably mounted on the body of plural component sprayer 10. Trigger 14 can be actuated by the hand grasping handle 12. Trigger 14 controls spraying by plural component sprayer 10. Actuator 16 is configured to control the position of spray control assembly 20, thus activating and deactivating spraying by plural component sprayer 10. Actuator 16 is operably associated with trigger 14 to be actuated by trigger 14. In the example shown, actuator 16 includes a cylinder 34 that forms a portion of the body of plural component sprayer 10 and piston 36 disposed within the cylinder 34. Tab lock 38 is formed on a shaft of piston 36 and the head of piston 36 is disposed in the cylinder 34. Tab lock 38 is configured to receive the tail 72 of receiver 24 to connect spray control assembly 20, and thus mix chamber assembly 22, to actuator 16. Trigger 14 is configured to cause displacement of actuator 16, which in turn displaces spray control assembly 20 axially to control spraying by plural component sprayer 10. In the example shown, trigger 14 interfaces with a valve (not shown) within the body of plural component sprayer 10 (e.g., within handle 12) to control the flow of compressed air to cylinder 34 to control displacement of the pneumatic piston 36 in first axial direction AD1 and second axial direction AD2.

Mounting head 18 is connected to cylinder 34. In the example shown, mounting head 18 is connected to cylinder 34 by mount ring 30. Mount ring 30 is threadedly connected to cylinder 34, though it is understood that other connection types are possible. Mounting head 18 includes internal flowpaths that direct the individual component materials to seal assemblies 32a, 32b and thus downstream to mixer 46.

Central aperture 40 extends axially through mounting head 18 on axis AA. Material feed apertures 42a, 42b intersect with central aperture 40. In the example shown, material feed apertures 42a, 42b extend through mounting head 18 to central aperture 40. Seal assemblies 32a, 32b are mounted in material feed apertures 42a, 42b, respectively. Seal bodies 74a, 74b are disposed in and connected to mounting head 18 within material feed apertures 42a, 42b, respectively. Seal member 76a is at least partially disposed within seal body 74a and is retained in seal body 74a. Spring 80a is disposed within seal body 74a and biases seal member 76a towards central aperture 40 and axis AA. Material flowpath 78a is formed through seal member 76a and defines a flowpath for a component material to exit material feed aperture 42a to mixer 46. Seal member 76b is at least partially disposed within seal body 74b and is retained in seal body 74b. Spring 80b is disposed within seal body 74b and biases seal member 76b towards central aperture 40 and axis AA. Material flowpath 78b is formed through seal member 76b and defines a flowpath for a component material to exit material feed aperture 42b to mixer 46. Purge chamber 88 is formed by a portion of central aperture 40. Purge chamber 88 is configured to be pressurized with a purge air portion of compressed air during operation of plural component sprayer 10.

Retaining cap 28 is configured to connect to mounting head 18. Retaining cap 28 can secure seal assemblies 32a, 32b within material feed apertures 42a, 42b. Retaining cap 28 can connect to mounting head 18 in any desired manner, such as by interfaced threading, among other options.

Inlet manifold 26 is connected to mounting head 18. Inlet manifold 26 is configured to receive supply lines (not shown) at fluid connectors 82, which supply lines provide the first and second component materials to plural component sprayer 10. Inlet manifold 26 provides the first and second component materials to mounting head 18. Inlet manifold 26 can include internal valves that allow the user to turn off flow through inlet manifold 26 during assembly and disassembly of plural component sprayer 10. Knobs 84 are connected to the internal valves and can be manipulated by a user to change a position of the valve components.

Mix chamber assembly 22 is at least partially disposed within plural component sprayer 10. In the example shown, mix chamber assembly 22 is a dynamic mix chamber assembly 22 that is movable along axis AA between a spray state and a non-spray state. As such, axis AA can also be referred to as a reciprocation axis. As discussed in more detail below, some examples of mix chamber assembly 22 are configured such that mixer 46 is a stationary mixer 46 that does not itself move along axis AA between the spray state and non-spray state of plural component sprayer 10. In some examples, the non-spray state can be referred to as a purge state, during which mixer 46 receives purge air, such as from purge chamber 88, and emits the purge air through orifice 54. Mix chamber assembly 22 is mounted to receiver 24 to form spray control assembly 20. Mic chamber assembly 22 can also be referred to as a forward element of spray control assembly 20 and receiver 24 can also be referred to as a rearward element of spray control assembly 20.

Receiver 24 is connected to actuator 16. Tail 72 of receiver 24 is disposed within tab lock 38 to connect spray control assembly 20 to piston 36. While tail 72 is shown as integrally formed with mount body 64, it is understood that tail 72 can be formed as or on a separate component connected to mount body 64. Receiving chamber 66 is formed within mount body 64. Receiving chamber 66 is disposed on axis AA. Receiving chamber 66 can be a uniform chamber about axis AA. In the example shown, receiving chamber 66 includes a contoured portion that narrows in second axial direction AD2. In some examples, receiving chamber 66 narrows proximate feed bores 68a, 68b. More specifically, receiving chamber 66 narrows beginning on a first axial side of feed bores 68a, 68b and continues to narrow on the second, opposite axial side of feed bores 68a, 68b. The receiving chamber 66 can be formed as a conical or frustoconical chamber. It is understood that the terms conical and frustoconical can be used interchangeably such that the term conical does not require convergence to a point unless otherwise specified.

Feed bores 68a, 68b extend through mount body 64 to receiving chamber 66. In the example shown, feed bores 68a, 68b extend radially through mount body 64 relative to axis AA and to receiving chamber 66. Feed bores 68a, 68b can be aligned across receiving chamber 66. In some examples, feed bores 68a, 68b can be aligned such that feed bores 68a, 68b are coaxial with each other. Feed bores 68a, 68b can be oriented on axes orthogonal to axis AA. In some examples, the axes through feed bores 68a, 68b are offset relative to each other and one or both of the axes can be offset (above or below) relative to the axis AA. For example, the opposing feed bores 68a, 68b can be offset such that feed bores 68a, 68b are partially rather than fully aligned. For example, feed bores 68a, 68b may only partially overlap. The offset can be about 0.011 inches (about 0.279 millimeters), among other options.

Cap retainer 70 is disposed at an end of receiver 24 opposite tail 72. In the example shown, cap retainer 70 is formed separately from the other components of receiver 24 and connected to mount body 64. Cap retainer 70 is disposed coaxially with receiving chamber 66. In the example shown, cap retainer 70 is mounted to an exterior side of mount body 64 such that mount body 64 is at least partially disposed within cap retainer 70. In the example shown, cap retainer 70 interfaces with head seal 86, which head seal 86 is supported by mounting head 18. Cap retainer 70 sealingly interfaces with head seal 86 with spray control assembly 20 in both the spray state and the non-spray state. The interface between cap retainer 70 and head seal 86 prevents purge air from escaping from purge chamber 88 except through mix chamber assembly 22.

Mix chamber assembly 22 is retained on plural component sprayer 10 by a locking interface 90. In the example shown, mix chamber assembly 22 is mounted to receiver 24 by locking interface 90 such that mix chamber assembly 22 is connected to receiver 24 to move axially with receiver 24. For example, the locking interface can be formed by a threaded connection, a bayonet-type connection, a quick-connect fitting (e.g., sliding sleeve and ball detents), among other types of connections. In the example shown, mix chamber assembly 22 is connected to receiver 24 by a threaded interface between air cap 44 and cap retainer 70. Mix chamber assembly 22 is configured to receive the individual component materials, combine the individual component materials to form the plural component material, and emit the resultant plural component material as a spray. Mix chamber assembly 22 forms a quick connect mix chamber that can be quickly and easily mounted to and dismounted from plural component sprayer 10.

Air cap 44 is mounted to mixer 46 to form the mix chamber assembly 22. Air cap 44 can be mounted to mixer 46 such that air cap 44 can rotate relative to mixer 46 (e.g., about axis AA). In the example shown, a portion of air cap 44 is disposed in annular recess 56 formed on mixer 46 to connect air cap 44 to mixer 46. An axial receiver 57 is formed within the annular recess 56 between the retaining head 56 and mix chamber body 48. In some examples, air cap 44 can be freely rotatable about mixer 46 while mix chamber assembly 22 is dismounted from receiver 24. In the example shown, air cap 44 forms a component of the locking interface 90 such that air cap 44 connects mix chamber assembly 22 to plural component sprayer 10. In the example shown, air cap 44 includes threading configured to interface with threading formed on receiver 24 (e.g., on cap retainer 70).

While air cap 44 is described as mounted to mixer 46, it is understood that not all examples are so limited. For example, air cap 44 can interface with mixer 46 to bias mixer 46 into receiver 24 without air cap 44 being mounted to mixer 46. The air cap 44 can bias the mixer 46 by pushing the mixer 46 into the receiving chamber 66 of receiver 24. The air cap 44 can interface with mixer 46, such as with a shoulder of mixer, and can connect to the plural component sprayer 10, such as to receiver 24, to secure air cap 44 to plural component sprayer 10. The air cap 44 can thus interface with mixer 46 without being connected to mixer 46. The air cap 44 interfaces with mixer 46 to retain mixer 46 on plural component sprayer. It is further understood that air cap 44 can directly interface with mixer 46 (e.g., by direct contact therebetween) or indirectly interface with mixer 46 (e.g., by a component disposed therebetween). For example, air cap 44 can indirectly interface with mixer 46 in examples where a ring or other component is disposed axially between the face of air cap 44 that interfaces with mixer 46 and the face of mixer 46 that interfaces with air cap 44.

Air cap 44 is configured to interface with cap seal 92 with mix chamber assembly 22 in the spray state. Cap seal 92 is supported by retaining cap 28. Air cap 44 shifts axially with spray control assembly 20 into and out of engagement with cap seal 92. Plural component sprayer 10 is in the spray state in the example shown in FIG. 1B such that feed bores 68a, 68b are aligned with material flowpaths 78a, 78b. Spray control assembly 20 shifts in the first axial direction AD1 from the spray state to the non-spray state. With spray control assembly 20 in the non-spray state (which can also be referred to as a purge state) air cap 44 is disengaged from cap seal 92 to allow compressed air to flow out of plural component sprayer 10 between air cap 44 and retaining cap 28. That compressed air can flow over air cap 44 to blow residue off of air cap 44 and thereby prevent accumulation of and curing of the plural component material on air cap 44. In addition, feed bores 68a, 68b are exposed to purge chamber 88 with sprayer 10 in the purge state, such that the purge air can flow through mix bore 52 and blow any residual material out of mixer 46.

Mixer 46 is at least partially disposed within receiving chamber 66 with mix chamber assembly 22 mounted to plural component sprayer 10. Air cap 44 biases mixer 46 into the receiving chamber 66 to mount mixer 46 to plural component sprayer 10. Mixer 46 can also be referred to as a mix chamber. Retaining head 60 is disposed at a first axial end of mixer 46. As shown, mixer 46 includes retaining head 60 an cylindrical extension that projects axially from retaining head 60 on an opposite side of retaining head 60 from neck 58 and away from neck 58. The orifice 54 can be formed through a distal face of that axial extension. Neck 58 extends from a first axial end 49 of mix chamber body 48 and between mix chamber body 48 and retaining head 60. Neck 58 is formed as a reduced diameter portion of mixer 46. Annular recess 56 is formed axially between mix chamber body 48 and retaining head 60 around neck 58. Retaining head 60 is spaced from first axial end 49 of the mix chamber body 48 such that an axial receiver 57 is formed between the retaining head 60 and the mix chamber body 48. In some examples, the axial receiver 57 is defined axially between the threads of retaining head 60 and the first axial end 49 of chamber body 48. Retaining head 60 is cantilevered from mix chamber body 48, in the example shown.

In the example shown, mixer 46 is contoured at a second axial end opposite retaining head 60. The contoured end of mixer 46, which can also be referred to as a seal head, is configured to interface with the contoured portion of receiving chamber 66 to form a tight fit therebetween. As discussed in more detail below, the locking interface 90 between mix chamber assembly 22 and plural component sprayer 10 can exert a driving force on mixer 46 in second axial direction AD2 to push mixer 46 into receiving chamber 66 and form the seal between mixer 46 and receiver 24. The locking interface 90 can thus preload the seal between mixer 46 and plural component sprayer 10 (e.g., between mixer 46 and receiver 24 within receiving chamber 66).

Inlet bores 50a, 50b extend into mix chamber body 48. Inlet bores 50a, 50b extend from the exterior of mix chamber body 48 to mix bore 52 within mix chamber body 48. Mix bore 52 extends axially through mix chamber body 48 to orifice 54 formed in mixer 46. In the example shown, mix bore 52 is axially elongate and is disposed coaxially with the spray axis AA. Mix bore 52 is coaxial with receiving chamber 66 formed in mount body 64. In the example shown, mix bore 52 extends through mix chamber body 48, neck 58, and retaining head 60. Inlet bores 50a, 50b define flowpaths for the individual component materials to flow into mixer 46 and to mix bore 52. In the example shown, inlet bores 50a, 50b extend radially through mix chamber body 48 to mix bore 52. Inlet bores 50a, 50b can be coaxial with each other. Inlet bores 50a, 50b can be oriented on axes orthogonal to axis AA. In some examples, the axes through inlet bores 50a, 50b are offset relative to each other and one or both of the axes can be offset (above or below) relative to the axis AA. For example, the opposing inlet bores 50a, 50b can be offset such that inlet bores 50a, 50b are partially rather than fully aligned. For example, inlet bores 50a, 50b may only partially overlap. The offset can be about 0.011 inches (about 0.279 millimeters) between the center of each inlet bore 50a, 50b, among other options. With mixer 46 mounted to receiver 24, inlet bores 50a, 50b are aligned with feed bores 68a, 68b, respectively, to receive the component materials from feed bores 68a, 68b. The individual component materials combine within mix bore 52 to form the plural component material, and the plural component material is emitted as the spray from orifice 54.

Mixer 46 is self-aligning on axis AA during mounting to ensure alignment between inlet bores 50a, 50b and feed bores 68a, 68b. An anti-rotation interface can restrict mixer 46 to only axial movement relative to receiver 24 during mounting to provide the desired alignment. Rotation locks 62a, 62b form an anti-rotation interface 61 that prevents rotation of mixer 46 relative to receiver 24. In the example shown, rotation lock 62a is formed as a projection extending from mixer 46. More specifically, rotation lock 62a extends radially from mix chamber body 48 beyond an outer radial surface of mix chamber body 48. In the example shown, rotation lock 62b is formed as a slot formed on receiver 24. More specifically, rotation lock 62b is formed as a slot within receiving chamber 66 and is formed in mount body 64. The interface between rotation locks 62a, 62b prevents mixer 46 from rotating on axis AA during mounting and dismounting of mix chamber assembly 22 on plural component sprayer 10. While rotation lock 62a is shown as a projection and rotation lock 62b is shown as a slot, it is understood that rotation lock 62b can be formed as a projection (e.g., extending into receiving chamber 66 from a radial surface defining receiving chamber 66) and rotation lock 62a can be formed as a slot (e.g., extending into mix chamber body 48). Further, while rotation locks 62a, 62b are shown as a projection and slot interface, it is understood that mixer 46 and receiver 24 can interface in any desired manner suitable for preventing rotation of mixer 46 relative to receiver 24 during mounting and dismounting. For example, mixer 46 and receiving chamber 66 can additionally or alternatively have complementary non-circular cross-sections taken orthogonal to axis AA (e.g., oval, square, triangular, polygonal, etc.), among other options. In some examples, interfacing flats can be formed on mixer 46 and receiver 24 to prevent rotation of mixer 46 relative to receiver 24. The interface between rotation locks 62a, 62b prevents rotation of mixer 46 relative to receiver 24 to ensure alignment of inlet bores 50a, 50b with feed bores 68a, 68b to form the flowpaths from outside of mix chamber assembly 22 to mix bore 52.

During operation, plural component sprayer 10 is placed in the spray state (shown in FIG. 1B) to initiate spraying of the plural component material and plural component sprayer 10 is placed in a non-spray state to stop spraying the plural component material. The user can support, manipulate, and operate plural component sprayer 10 with a single hand. The individual component materials enter plural component sprayer 10 at inlet manifold 26 and flow through mounting head 18 to material feed apertures 42a, 42b. The component materials enter seal bodies 74a, 74b and flow through material flowpaths 78a, 78b through seal member 76a, 76b, respectively. Seal members 76a, 76b interface with and seal against the lateral sides of receiver 24. The seals are maintained as receiver 24 shifts axially relative to seal members 76a, 76b.

A first portion of compressed air, which first portion can be referred to as purge air, is provided to purge chamber 88. With mix chamber assembly 22 in the non-spray state, the purge air flows through feed bores 68a, 68b to inlet bores 50a, 50b, flows through inlet bores 50a, 50b to mix bore 52, and flows through mix bore 52 to orifice 54 where the purge air is emitted from plural component sprayer 10. A second portion of compressed air flows to the chamber formed axially between head seal 86 and cap seal 92. The second portion is emitted with plural component sprayer 10 in the non-spray state and flows over air cap 44 to blow residue off of air cap 44.

The user grasps handle 12 and depresses trigger 14 to initiate spraying. Piston 36 pulls receiver 24 in second axial direction AD2 from the non-spray state to the spray state. Mix chamber assembly 22 shifts in second axial direction AD2 with receiver 24 due to the locking interface 90 between mix chamber assembly 22 and receiver 24. More specifically, mix chamber assembly 22 shifts in second axial direction AD2 with receiver 24 due to the locking interface 90 between air cap 44 and cap retainer 70. Mix chamber assembly 22 shifts in the second axial direction AD2 to the spray state shown in FIG. 1B such that feed bores 68a, 68b are aligned with the material flowpaths 78a, 78b through seal members 76a, 76b, respectively. The individual component materials enter spray control assembly 20 through feed bores 68a, 68b, flow through feed bores 68a, 68b to enter mix chamber assembly 22 at inlet bores 50a, 50b, flow through inlet bores 50a, 50b to mix bore 52, are combined in mix bore 52 to form the plural component material, and the resultant plural component material is emitted through orifice 54.

The user releases trigger 14 to stop spraying. Piston 36 shifts in first axial direction AD1 (e.g., due to compressed air being provided to cylinder 34) and drives spray control assembly 20 in the first axial direction AD1 and to the non-spray state. Mix chamber assembly 22 is fluidly disconnected from the material flowpaths 78a, 78b through seal assemblies 32a, 32b while in the non-spray state. Feed bores 68a, 68b shift from being aligned with the material flowpaths 78a, 78b through seal assemblies 32a, 32b with mix chamber assembly 22 in the spray state to being open within and fluidly connected to purge chamber 88 during the non-spray state. The purge air enters spray control assembly 20 through feed bores 68a, 68b, enters mixer 46 through inlet bores 50a, 50b, and flows through inlet bores 50a, 50b and mix bore 52 to drive any remaining material within mix chamber assembly 22 downstream and out of orifice 54. The purge air thus blows any remaining material out of mix chamber assembly 22 to purge mix chamber assembly 22 of residue. In some examples, the purge air can continually flow through mix chamber assembly 22 with mix chamber assembly 22 in the non-spray state. The purge air can prevent curing of the plural component material within mixer 46.

Mix chamber assembly 22 is a quick-connect assembly that can be quickly and easily assembled to and disassembled from plural component sprayer 10. Mix chamber assembly 22 can be dismounted from plural component sprayer 10 by breaking the locking interface 90 between mix chamber assembly 22 and receiver 24 and then pulling mix chamber assembly 22 in first axial direction AD1 away from plural component sprayer 10. No components of plural component sprayer 10 other than mix chamber assembly 22 need to be removed from plural component sprayer 10 to remove mixer 46. The mixer 46, including mix bore 52 within which the plural component material is formed, can be removed, cleaned, and reinstalled on plural component sprayer 10 without disassembling any other components of plural component sprayer 10. The mixer 46 can be removed and replaced with a mixer of the same or different configuration. For example, a mixer 46 that is clogged or has been worn can be quickly and easily removed and replaced without disassembling other components of plural component sprayer 10. In some examples, the mixer 46 can be removed and replaced with a different mixer 46 to change the nature of the spray emitted by plural component sprayer 10. For example, a second mix chamber assembly 22 having a second mixer 46 with differently sized inlet bores 50a, 50b and/or a differently sized mix bore 52 relative to the first mixer 46 and/or a differently shaped/sized orifice 54 can be installed on plural component sprayer 10. The second mixer 46 can be configured to spray finer or coarser detail and/or be configured for spraying different component materials. Plural component sprayer 10 can thus be easily modified for different detail by simply swapping mixer 46 without disassembling any other components of plural component sprayer 10. Mix chamber assembly 22 thereby reduces downtime and increases the efficiency of spray operations.

In the example shown, the locking interface 90 is broken by rotating air cap 44 about axis AA and relative to both mixer 46 and cap retainer 70. The rotation unthreads air cap 44 from cap retainer 70 to break the locking interface 90. Mix chamber assembly 22 is pulled in axial direction AD1 to withdraw mixer 46 from receiving chamber 66. For example, the user can grasp air cap 44 and pull on air cap 44 to pull mix chamber assembly 22 axially. Air cap 44 exerts a force on mixer 46 by interfacing with retaining head 60 at a location within the annular recess 56 to pull mixer 46 out of receiving chamber 66. The mixer 46 can thereby be removed and serviced without disassembling plural component sprayer 10 and without the use of tools.

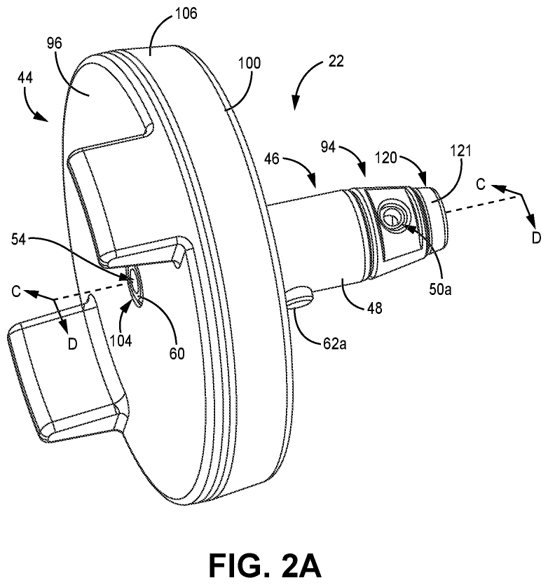

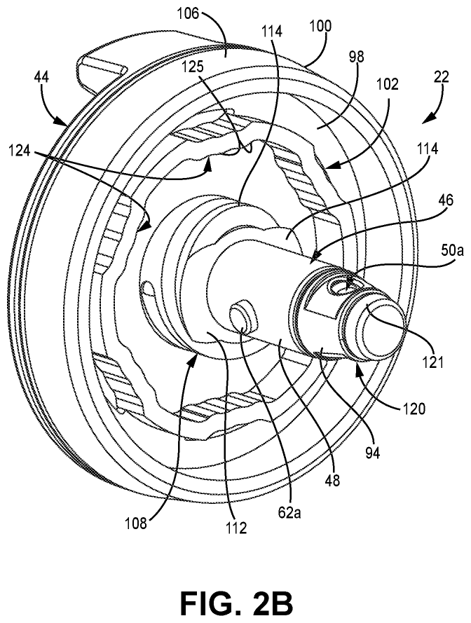

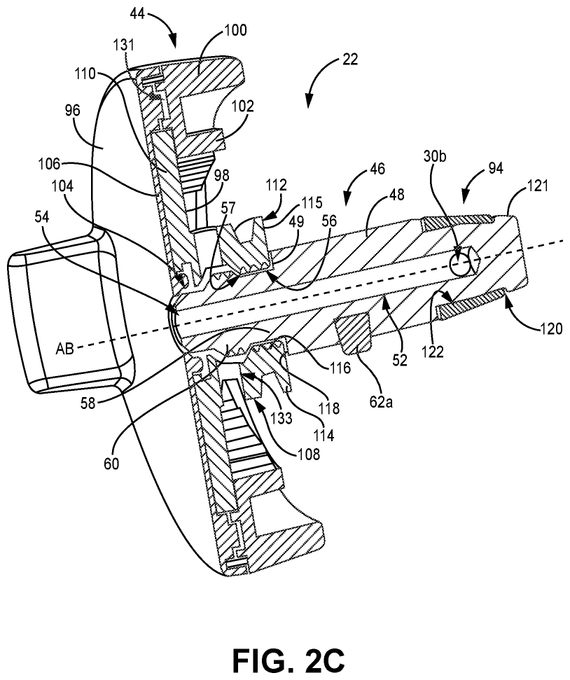

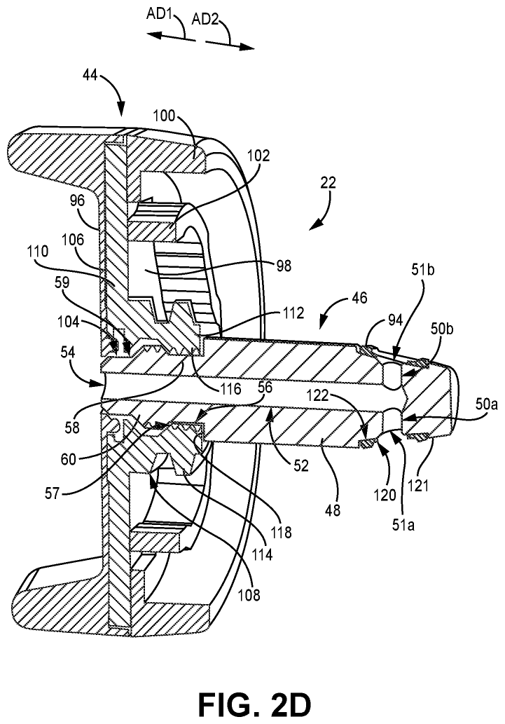

FIG. 2A is a first isometric view of mix chamber assembly 22. FIG. 2B is a second isometric view of mix chamber assembly 22. FIG. 2C is a cross-sectional view of mix chamber assembly 22 taken along line C-C in FIG. 2A. FIG. 2D is a cross-sectional view of mix chamber assembly 22 taken along line D-D in FIG. 2A. FIGS. 2A-2D will be discussed together. Mix chamber assembly 22 includes air cap 44, mixer 46, and chamber seal 94. Air cap 44 includes outer axial side 96, inner axial side 98, outer annular projection 100, inner annular projection 102, cap opening 104, cap body 106, and mount 108. Inner annular projection 102 includes protrusions 124. Mount 108 includes cap end 110, mount end 112, cap threads 114, and mount extension 116. Mixer 46 includes mix chamber body 48; inlet bores 50a, 50b; mix bore 52; orifice 54; annular recess 56; neck 58; retaining head 60; and rotation lock 62a. Mix chamber body 48 includes shoulder 118 and seal head 120. Seal recess 122 is formed in surface 121 of seal head 120.

Air cap 44 forms an end portion of a sprayer when air cap 44 is mounted to the sprayer. Air cap 44 is mountable to and dismountable from the sprayer. Air cap 44 includes a central opening 104 that extends around an orifice 54 through which the spray is emitted from the sprayer. Air cap 44 protects components of sprayer from drifting spray particles. Air cap 44 further routes air to prevent buildup on air cap 44 and other components of sprayer 10. Air cap 44 includes mount 108 on which the body 106 of air cap 44 is overmolded. Mount 108 interfaces with components of sprayer 10 to retain mixer 46 on sprayer 10 and secure mixer 46 to sprayer 10.

Air cap 44 is separate from mixer 46 and can be removed from mixer 46 and replaced with a different air cap 44 or can be attached to different mixers 46 for use. Air cap 44 provides significant advantages. Air cap 44 is mountable to different ones of mixers 46 such that a single air cap 44 can be used on multiple sprayers. The air cap 44 includes mount 108 that forms a structural portion that can connect to mixer 46, while the cap body 106 can be overmolded on mount 108. The overmolded cap body 106 reduces the weight of air cap 44 and reduces material costs associated with air cap 44. The less resilient material forming cap body 106 directs airflow and can interface with components of sprayer 10 to generate air seals. The more resilient material forming mount 108 mount forms structural interfaces between air cap 44 and mixer 46 (e.g., between mount extension 116 and retaining head 60) and forms structural interfaces between air cap 44 and sprayer 10 (e.g., by threads 114).

Mixer 46 defines the terminal portions of the flowpaths of each of the two component materials through sprayer 10. The individual component materials combine and chemically interact within mixer 46 to form the plural component material that is emitted through orifice 54. Mixer 46 is mountable to and removable from a sprayer 10 without disassembly of the body of the sprayer 10 or other fluid-handling components of the sprayer 10. Mixer 46 is the only fluid-handling component of sprayer 10 that needs to be accessed and handled to remove the portion of sprayer 10 that combines the materials together. Mixer 46 is the portion of sprayer 10 most susceptible to clogging due to material buildup and curing, which occurs in portions of the flowpaths in which the component materials are combined. Mixer 46 being mountable and dismountable as a discrete component facilitates quick swapping of mixer 46 (due to clogging or to reshape the spray pattern), reduces downtime, provides time and material cost savings, and protects portions of the individual material flowpaths upstream of mix bore 52 from cross-over that can cause curing.

Mix chamber assembly 22 is configured to receive individual component materials, mix the individual component materials to form a plural component material, and emit the plural component material as a spray. Air cap 44 is mounted to mixer 46 to form mix chamber assembly 22. In the example shown, air cap 44 is formed by cap body 106 being disposed on mount 108. Mount 108 of air cap 44 connects air cap 44 to mixer 46. Cap opening 104 extends axially through air cap 44. Mixer 46 extends into and at least partially through cap opening 104. In the example shown, cap opening 104 is formed through mount 108. Mixer 46 is oriented on axis AB, which can be referred to as the mix chamber axis. Axis AB can be coaxial with the spray axis AA (FIGS. 1A and 1B) with mixer 46 mounted to plural component sprayer 10.

Outer axial side 96 of air cap 44 is configured to be oriented in first axial direction AD1 (FIGS. 1B and 1C) with mix chamber assembly 22 mounted to a plural component sprayer. Outer axial side 96 is oriented out of plural component sprayer 10. Outer axial side 96 includes a surface extending radially from cap opening 104. The surface of outer axial side 96 can be frustoconical or planar, among other options. Inner axial side 98 of air cap 44 is configured to be oriented in second axial direction AD2 (FIGS. 1B and 1C) with mix chamber assembly 22 mounted to a plural component sprayer. Inner axial side of air cap 44 is oriented towards plural component sprayer 10 with air cap 44 mounted to sprayer 10. Inner axial side 98 can be formed partially by the material forming mount 108 and the material forming cap body 106.

Outer annular projection 100 extends in second axial direction AD2. Outer annular projection 100 is formed at an outer radial side of air cap 44 relative to axis AB and is formed as part of cap body 106. Outer annular projection 100 is configured to interface with cap seal 92 with plural component sprayer 10 in the spray state (shown in FIG. 1B). Outer annular projection 100 projects axially in second axial direction AD2 and retains air in the sprayer 10 during spraying, preventing interference with the spray pattern, and allows discharge of air over the radial exterior of air cap 44 to clean air cap 44 when sprayer 10 is not spraying. Outer annular projection 100 extends in the second axial direction AD2 from the second axial side 98 of cap body 106, opposite the first axial side 96 of cap body 106, such that the mount 108 is at least partially radially overlapped by the outer annular projection 100. Parts can be considered to radially overlap when a radial line from the axis AB extends through each of those radially overlapped components. The outer annular projection 100 is disposed at an outer radial edge of the cap body 106.

Inner annular projection 102 extends in second axial direction AD2. Inner annular projection 102 extends from inner axial side 98 of air cap 44. Inner annular projection 102 is formed as part of the cap body 106. In the example shown, inner annular projection 102 extends a shorter axial distance than outer annular projection 100. In the example shown, inner axial projection 102 is formed as a portion of mount 108, which mount 108 forms a supporting portion of air cap 44 that connects to mixer 46, as discussed in more detail below. Inner annular projection 102 extends in the second axial direction AD2 from the second axial side 98 of cap body 106, opposite the first axial side 96 of cap body 106, such that the mount 108 is at least partially radially overlapped by the inner annular projection 102.

Air cap 44 includes protrusions 124 that rotatably secure air cap 44 to sprayer 10. Protrusions 124 interface with a component of sprayer 10 to prevent air cap 44 from unthreading from sprayer 10 during operation of sprayer 10. Protrusions 124 interface with sprayer 10 to inhibit rotation of air cap 44. Protrusions 124 are disposed on inner axial side 98 of air cap 44 and extend radially inward towards axis AB. It is understood, however, that while protrusions 124 are shown as formed on inner annular projection 102, protrusions 124 can be configured to interface with any one or more of multiple different components of sprayer 10 to rotatably fix air cap 44 to sprayer 10. As discussed in more detail below, protrusions 124 can be formed outer annular projection 100 in examples including a stationary mixer 46. In the example shown, air cap 44 includes multiple protrusions 124 spaced annularly about the axis AB. It is understood that air cap 44 can include as many or as few protrusions 124 as desired. Air cap 44 includes an annular array of protrusions 124 in the example shown. Protrusions 124 are configured to interface with a portion of plural component sprayer 10 (e.g., the exterior of cap retainer 70) to prevent rotation of air cap 44 about axis AB with mix chamber assembly 22 mounted to plural component sprayer 10.

In the example shown, each protrusion 124 includes an array of cap teeth 125 that extend radially inward towards the axis AB from the inner annular ring 102. As such, each protrusion 124 can be considered to include an array of interposed cap teeth 125 and notches that are configured to interface with portions of receiver 24 to prevent undesired rotation of air cap 44 with mix chamber assembly 22 mounted to the plural component sprayer 10. In some examples, however, air cap 44 may not include protrusions 124. In other examples, protrusions 124 can be formed such that each protrusion 124 includes a single tooth. For example, each protrusion 124 can be formed as a single tooth that interfaces with a portion of receiver 24 to provide a rotation lock interface.

Mount 108 projects in second axial direction AD2 relative to inner axial side 98 of air cap 44. Mount 108 is configured to structurally support other components of air cap 44. Mount 108 can interface with components of sprayer 10 to secure components to sprayer 10. Mount 108 is configured to interface with mixer 46 to connect air cap 44 and mixer 46 and form mix chamber assembly 22. Mount 108 is further configured to connect with a portion of plural component sprayer 10 to mount mix chamber assembly 22 to plural component sprayer 10. Cap opening 104 extends fully through mount 108 along axis AB. Cap end 110 of mount 108 interfaces with cap body 106. In the example shown, cap body 106 is overmolded on cap end 110. In the example shown, cap end 110 is a flange extending radially outward relative to axis AB. It is understood, however, that cap end 110 can be of any suitable configuration for connecting with the cap body 106 of air cap 44. Mount end 112 is an opposite axial end of mount 108 from cap end 110. Mount end 112 is configured to interface with both mixer 46 and plural component sprayer 10. Mount end 112 is formed by a portion of mount 108 projecting axially outward from cap end 110.

Mount 108 can be formed from durable polymer or a metal, among other options. Cap body 106 can be overmolded onto mount 108, among other connection options. For example, cap body 106 can be formed by a low surface energy (LSE) plastic, among other options. In the example shown, cap body 106 connects to cap end 110 of mount 108. For example, cap end 110 can include a radially extending flange that cap body 106 is overmolded onto. In some examples, cap body 106 can be formed from multiple components assembled together that capture cap end 110 therebetween, such that cap end 110 is sandwiched between those components of cap body 106. It is understood that, in some examples, air cap 44 can be manufactured as a single component.

In the example shown, cap end 110 extends radially outward from the cap opening 104 such that the mount 108 at least partially axially overlaps with one or more of the annular projections 100, 102. The cap end 110 extending to at least partially axially overlap with annular projection 102 provides structural rigid backing support at annular projection 102 that prevents deformation at protrusions 124. The support strengthens the connection formed between protrusions 124 and a mounted component of sprayer 10.

In the example shown, an axial gap 131 is formed between first axial side 96 and second axial side 98 of air cap body 106. In the example shown, axial gap 131 is formed between the overmolded portions of the first and second axial sides 96, 98. The axial gap 131 is disposed radially outward of mount 108. The axial gap 131 is disposed radially outward of cap end 110 such that no portion of axial gap 131 is formed by or axially overlaps with cap end 110, though it is understood that not all examples are so limited. The axial gap 131 is formed such that axial gap 131 is defined axially by only the material overmolded on mount 108. In some examples, the material forming cap body 108 is configured to flex back into shape. Axial gap 131 allows the ring portion 103, which is formed as a portion of cap body 106 separate from and supported by mount 108, to flex as protrusion 124 passes over and through notches on the sprayer 10. Axial gap 131 facilitates a springlike engagement of protrusions 124 on sprayer 10. Recess 133 facilitates bending between the can end 110 and mount end 112 to facilitate bending between cap body 106 portion of air cap 44 with mount end 112 of mount 108, facilitating spraying by a wide array of sprayers having different sprayer configurations.

Cap threads 114 are formed on mount end 112 of mount 108. Cap threads 114 form exterior threading on mount end 112 in the example shown. Cap threads 114 are configured to interface with a component of plural component sprayer 10 to mount mix chamber assembly 22 to plural component sprayer 10. Mount extension 116 is formed on mount end 112 of mount 108. In the example shown, mount extension 116 is a radial projection extending radially inward towards axis AB. Mount extension 116 can be annular and extend fully around axis AB. Mount extension 116 is configured to be disposed within annular recess 56 with air cap 44 mounted to mixer 46. Mount extension 116 can also be referred to as an inner radial extension.

Mount extension 116 is configured to pass over retaining head 60 and into annular recess 56 to mount air cap 44 to mixer 46. In some examples, mount extension 116 includes interior threading on a radially inner side of mount extension 116. As such, mount end 112 can include both interior threads, on mount extension 116, and exterior threading, formed by cap threads 114. Retaining head 60 can include exterior threading complementary to the interior threading of mount extension 116.

The interfaced threading between mount extension 116 and retaining head 60 facilitates air cap 44 mounting to mixer 46. For example, mount extension 116 can be threaded over retaining head 60 until mount extension 116 enters into annular recess 56. The threading is disengaged with mount extension 116 disposed within annular recess 56. Mount extension 116 is thus disposed in the annular recess 56 such that air cap 44 is freely rotatable about axis AB. Mount end 112 can thereby include both first threads formed on an exterior radial side of mount 108 (e.g., cap threads 114) and second threads formed on an interior radial side of mount 108 (e.g., on mount extension 116). Mount extension 116 is sized such that mount extension 116 interfaces with retaining head 60 to prevent air cap 44 from being pulled axially off of mixer 46. The threads on retaining head 60 axially overlap with the threads on mount extension 116 such that a line parallel to axis AB passes through both retaining head 60 and mount extension 116. The threads on retaining head 60 thus prevent the threads on mount extension 116 from passing in first axial direction AD1. The interface between mount extension 116 and retaining head 60 prevents air cap 44 from being pulled linearly in first axial direction AD1 off of mixer 46 but allows for air cap 44 to be disconnected from mixer 46 by rotating relative to mixer 46 due to the threading. It is understood, however, that air cap 44 can mount to mixer 46 in any desired manner. For example, mount extension 116 can be formed from or include a compliant material that is compressed in reaction to retaining head 60 passing through cap opening 104 and expands into annular recess 56 after passing over retaining head 60, among other mounting options. Air cap 44 can be freely rotatable about axis AB with mount extension 116 disposed in annular recess 56.

The sprayer threaded interface between air cap 44 and sprayer 10, formed in part by cap threads 114, is a threaded interface independent of the assembly threaded interface between air cap 44 and mixer 46. The sprayer threaded interface is formed while the assembly threaded interface is not rotationally engaged. The sprayer threaded interface is formed with the mount extension 116 axially captured on mixer 46 between retaining head 60 and shoulder 118. Air cap 44 includes a retainer wall 115 that forms a distal end of mount 108, which retainer wall 115 is at least partially disposed within the annular recess 46. The sprayer threaded interface has a greater lead than the assembly threaded interface. As such, the sprayer threaded interface requires less rotation to form and break the sprayer threaded interface than is required to cause air cap 44 to thread into annular recess 56. The different thread leads prevent inadvertently unthreading both interfaces simultaneously.

Retaining head 60 is disposed at a first axial end of mixer 46 and seal head 120 is formed at a second axial end of mixer 46 opposite retaining head 60. Axial projection 59 extends from a first axial end of mix chamber body 48. While mixer 46 is shown as including a retaining head 60, it is understood that not all examples are so limited. For example, the axial projection 59 can include a cylindrical outer surface without the radial enlargement forming retaining head 60.

Seal head 120 can be integrally formed with mix chamber body 48. In some examples, seal head 120, retaining head 60, and mix chamber body 48 are formed as a unitary component. Neck 58 extends between and connects mix chamber body 48 and retaining head 60. Retaining head 60 is radially larger than neck 58 and mix chamber body 48 is radially larger than neck 58. In the example shown, a cylindrical projection extends between retaining head 60 and the spray orifice 54. In some examples, retaining head 60 can be considered to have a larger diameter than neck 58. In some examples, mix chamber body 48 can be considered to have a larger diameter than neck 58. Annular recess 56 is formed about neck 58 and is disposed axially between retaining head 60 and mix chamber body 48. Mix chamber body 48 can extend radially outward relative to neck 58 and retaining head 60.

Shoulder 118 is formed at an opposite axial end of annular recess 56 from retaining head 60. In the example shown, shoulder 118 is formed by a portion of mix chamber body 48 projecting radially outward relative to neck 58. Shoulder 118 can be considered to form an axial-most end of mix chamber body 48 opposite seal head 120. Shoulder 118 can be formed as a planar face oriented orthogonal to axis AB. Shoulder 118 is formed at an axial end of mix chamber body 48. Mount end 112 of mount 108 of air cap 44 is configured to interface with shoulder 118 with mix chamber assembly 22 mounted to plural component sprayer 10. Specifically, retainer wall 115 is configured to interface with shoulder 118 to exert a force on mixer 46 to mount and retain mixer 46 on sprayer 10. Air cap 44 can exert a driving force on mixer 46 by mount end 112 interfacing with shoulder 118. The axial driving force biases mixer 46 into receiving chamber 66 (in second axial direction AD2 in the example shown) to seat mixer 46 and load chamber seal 94.

Seal head 120 is disposed at an opposite axial end of mixer 46 from retaining head 60. In the example shown, inlet bores 50a, 50b extend from openings formed in the exterior of seal head 120 to mix bore 52. Seal head 120 can be considered to form a contoured portion of the mix chamber body 48, in some examples. As such, the mix chamber body 48 can be considered to be contoured such that at least one surface of the mix chamber body 48 is angled towards the axis along which mix bore 52 extends.

The exterior surface 121 of seal head 120 is contoured to facilitate a tight fit within plural component sprayer 10. In the example shown, seal head 120 is frustoconical and surface 121 narrows towards the distal end of mix chamber body 48, which distal end is at an opposite axial end from retaining head 60. While seal head 120 is shown as including a smoothly contoured single surface 121, seal head 120 can be include multiple surfaces converging towards axis AB. Seal recess 122 extends annularly about mix chamber body 48. Seal recess 122 is a depression extending into mix chamber body 48. In the example shown, seal recess 122 is formed on seal head 120. Seal recess 122 forms a seal receiving groove that is formed in an exterior surface of the seal head 120. Seal recess 122 extends annularly about the axis AB in the example shown. In the example shown, seal recess 122 includes an unobstructed seal path extending fully about the axis AB such that a single component seal can extend fully about the axis AB while continuously being within the seal recess 122. The chamber seal 94 is formed as a continuous component extending about the axis and disposed in the unobstructed seal path.

Chamber seal 94 is disposed at least partially within seal recess 122. Chamber seal 94 extends annularly about mixer 46. Chamber seal 94 is disposed about an inlet opening of the first inlet bore 50a and the chamber seal 94 is disposed about an inlet opening of the second inlet bore 50b such that the component materials enter inlet bores 50a, 50b by flowing through chamber seal 94. Chamber seal 94 can be a polymeric seal, among other options. The outer surface of chamber seal 94 is contoured to narrow towards axis AB as chamber seal 94 extends in second axial direction AD2, similar to seal head 120. Flow openings are formed as orifices through chamber seal 94 to provide flowpaths through chamber seal 94, allowing flow through chamber seal 94 between feed bores 68a, 68b and inlet bores 50a, 50b. Chamber seal 94 includes two orifices therethrough in the example shown, because the plural component sprayer 10 shown is configured to combine two component materials to form the plural component materials.

Rotation lock 62a extends radially from mixer 46. Rotation lock 62a is configured to interface with a portion of plural component sprayer 10 prevent mixer 46 from rotating about axis AB while installed on plural component sprayer 10. In some examples, rotation lock 62a can restrict mixer 46 to only linear movement during installation on and removal from plural component sprayer 10. Rotation lock 62a limits mixer 46 to axial movement to ensure proper alignment of inlet bores 50a, 50b to receive the individual component materials. In the example shown, rotation lock 62a is formed as a projection extending from mix chamber body 48. For example, rotation lock 62a can be formed by a set screw threaded into mix chamber body 48. It is understood, however, that rotation lock 62a can be of any desired form suitable for preventing rotation of mixer 46 about axis AB and relative to plural component sprayer 10.

Inlet bores 50a, 50b extend into mixer 46 and provide flowpaths for the individual component materials to enter into mixer 46. Each inlet bore 50a, 50b extends to and intersects with mix bore 52. Mix bore 52 extends axially through mixer 46 to orifice 54. Mix bore 52 extends within each of mix chamber body 48, neck 58, and retaining head 60. The individual component materials mix within mix bore 52 to form the plural component material that is emitted through orifice 54 as a spray. Inlet bore 50a includes an opening 51a that is formed through the surface 121 of seal head 120. Inlet bore 50b includes an opening 51b that is formed through the surface 121 of seal head 120. The openings 51a, 51b are formed on the sloped surface of mixer 46. The individual component materials enter inlet bores 50a, 50b through openings 51a, 51b, respectively. In the example shown, openings 51a, 51b are ovular due to the conical shape of the surface 121 and of the portion of the surface forming the base of seal groove 122. The base surface of seal groove 122 can be sloped similar to or the same as surface 121, in some examples.

Mixer 46 can be formed from a metal or polymer. For example, mix chamber body 48; annular recess 56; neck 58; retaining head 60, shoulder 118, and seal head 120 can be formed unitarily. In some examples, mixer 46 can be formed by molding, among other options. In some examples, inlet bores 50a, 50b, mix bore 52, and orifice 54 can be formed during the molding. In some examples, rotation lock 62a can be formed integral with mix chamber body 48. In some examples, mixer 46 is formed from a polymer. In some examples, mixer 46 can be formed from a plastic, such as a low surface energy plastic. In some examples, mixer 46 can be formed from ultrahigh molecular weight polyethylene (UHMW-PE), polytetrafluoroethylene (PTFE), polyetheretherketone (PEEK), nylon, among other options.

Mix chamber assembly 22 provides significant advantages. Mix chamber assembly 22 is mountable to and removable from a plural component sprayer 10 as a single component. Mix chamber assembly 22 provides both the air cap 44 and mixer 46 of plural component sprayer 10 in the single, discrete assembly. Mix chamber assembly 22 can be mounted to and removed from plural component sprayer 10 without requiring manipulation of or removal of other components of plural component sprayer 10. Mix chamber assembly 22 facilitates quick and simple access to mixer 46 such as to facilitate servicing of mixer 46. Mix chamber assembly 22 further facilitates quick changing between mix chambers 46 having differently sized inlet bores 50a, 50b and/or mix bores 52 and/or differently configured orifices 54 (e.g., flat, round, cat-eye, etc.) to facilitate spraying for different finishes and textures. Mix chamber assembly 22 thereby reduces downtime during servicing and increases spray operation efficiency. Air cap 44 can preload the seal around inlet bores 50a, 50b by biasing mixer 46 into a receiving chamber 66, thereby ensuring desired flow and preventing undesired leakage.

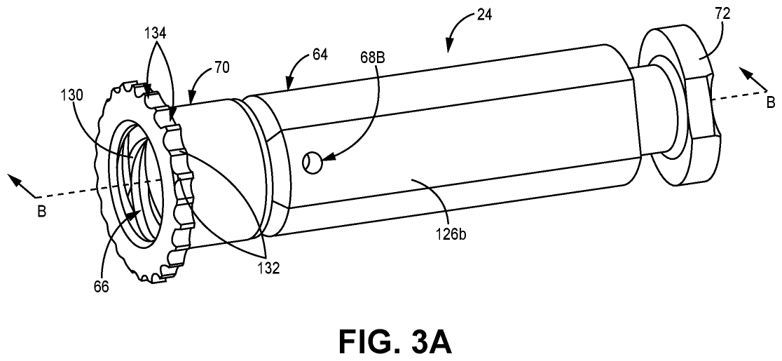

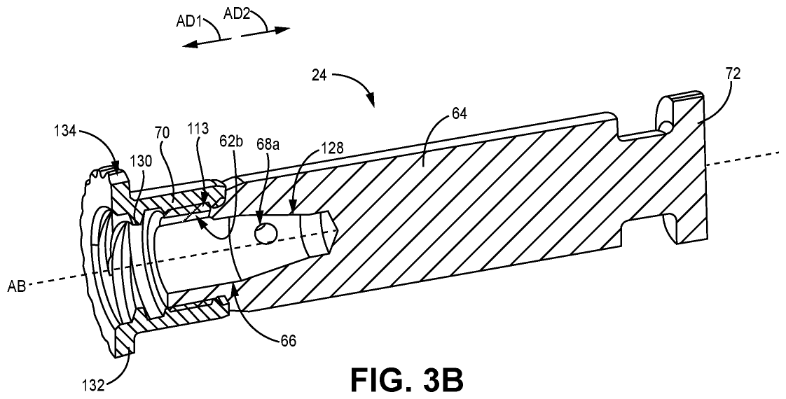

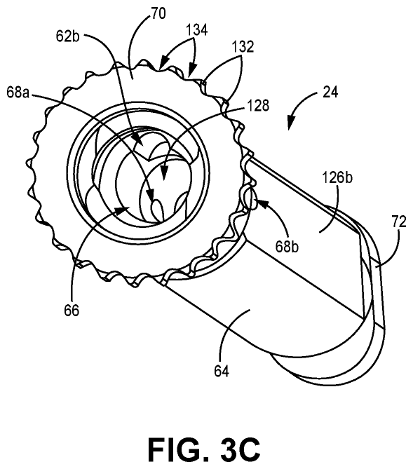

FIG. 3A is an isometric view of receiver 24. FIG. 3B is a cross-sectional view taken along line B-B in FIG. 3A. FIG. 3C is an isometric end view of receiver 24. FIGS. 3A-3C will be discussed together. Receiver 24 includes mount body 64; receiving chamber 66; feed bores 68a, 68b; cap retainer 70; tail 72; and rotation lock 62b. Mount body 64 includes lateral sides 126a, 126b. Receiving chamber 66 includes contoured chamber 128. Cap retainer 70 includes retainer threads 130 and retainer teeth 132 and retainer notches 134.

Receiver 24 is configured to mount within a plural component sprayer (e.g., plural component sprayer 10) and connect to an actuator of that plural component sprayer (e.g., actuator 16 best seen in FIG. 1B). Receiver 24 forms a portion of plural component sprayer 10 that mix chamber assembly 22 can be mounted to. Receiver 24 facilitates mix chamber assembly 22 being a dynamic component that shifts axially along axis AA (FIG. 1B) during operation.

Cap retainer 70 is disposed at a first axial end of receiver 24 and tail 72 is disposed at an opposite, second axial end of receiver 24. Tail 72 is configured to interface with the actuator 16, such as by being disposed in a slot (e.g., tab lock 38 shown in FIG. 1B). Cap retainer 70 is configured to interface with mix chamber assembly 22 to secure mix chamber assembly 22 to receiver 24. In some examples, cap retainer 70 is formed separately from other components of receiver 24 and assembled to those other components. For example, cap retainer 70 can be threaded onto mount body 64. In other examples, cap retainer 70 is integrally formed with the other components of receiver 24. In the example shown, cap retainer 70 is mounted to mount body 64 by threaded interface 113 between a neck portion of mount body 64 that extends axially from the main body portion of mount body 64. The neck portion is radially smaller than the main body portion of mount body 64, at least taken along the cross-sectional plane shown in FIG. 3B. Cap retainer 70 is configured to facilitate mounting of air cap 44 to the sprayer 10.

Cap retainer 70 defines a part of locking interface 90 by which receiver 24 interfaces with mix chamber assembly 22 to connect to mix chamber assembly 22. In the example shown, retainer threads 130 are formed on a radially inner side of cap retainer 70. Retainer threads 130 are configured to interface with cap threads 114 of mix chamber assembly 22 to secure mix chamber assembly 22 to receiver 24.

Retainer teeth 132 are formed on an outer radial side of cap retainer 70. Retainer teeth 132 can also be referred to as merlons. Retainer teeth 132 are formed in an annular array with retainer notches 134 disposed between adjacent ones of the retainer teeth 132. Retainer notches 134 can also be referred to as crenellations. Retainer teeth 132 project radially from the exterior surface of cap retainer 70. Retainer teeth 132 are formed as substantially triangular projections with flat or rounded outer radial surface. In other examples, retainer teeth 132 can be formed in a pyramidal shape with a square frustum. Retainer teeth 132 narrow circumferentially as retainer teeth 132 extend radially away from axis AB. During operation, protrusions 124, such as cap teeth 125 of each protrusion 124, can be disposed in retainer notches 134 and retained between retainer teeth 132, which interface rotationally locks air cap 44 to receiver 24 to prevent undesired unthreading of mix chamber assembly 22 from the plural component sprayer. More specifically, the cap teeth 125 of each protrusion 124 extend into a retainer notch 134 between adjacent retainer teeth 132. Protrusions 124 entering into retainer notches 134 between retainer teeth 132 also provides haptic feedback to the user during mounting and dismounting of mix chamber assembly 22 to indicate to the user that mix chamber assembly 22 is mounted to receiver 24. It is understood that retainer teeth 132 can be formed in any desired shape for retaining protrusions 124 therebetween.

Mount body 64 is elongate along axis AB. Lateral sides 126a, 126b of mount body 64 are formed as flat surfaces configured to interface with seal members 76a, 76b during operation. Feed bores 68a, 68b extend into mount body 64 through lateral sides 126a, 126b, respectively. Feed bores 68a, 68b extend between the exterior of mount body 64 and receiving chamber 66. Receiving chamber 66 is formed in mount body 64. Receiving chamber 66 is configured to receive mixer 46 with mix chamber assembly 22 mounted to plural component sprayer 10. Receiving chamber 66 extends axially into mount body 64 from the first axial end of mount body 64. Contoured chamber 128 extends further into mount body 64 from an initial portion of receiving chamber 66. Contoured chamber 128 is contoured to narrow radially as contoured chamber 128 extends in second axial direction AD2. In some examples, a full axial length of receiving chamber 66 can be contoured and formed by contoured chamber 128. Contoured chamber 128 narrows in a direction away from cap retainer 70 and towards tail 72. In the example shown, contoured chamber 128 is shown as a conical passage, through it is understood that contoured chamber 128 can be formed in any desired configuration for mating with seal head 120. The conical contoured chamber 128 is configured to interface with the conical seal head 120 to facilitate a fluid tight fit therebetween.

Rotation lock 62b is formed on receiver 24. Rotation lock 62b is configured to interface with a portion of mixer 46 to prevent rotation of mixer 46 about axis AB during mounting of mix chamber assembly 22. Preventing rotation of mixer 46 within receiving chamber 66 aligns inlet bores 50a, 50b with feed bores 68a, 68b to ensure that the component materials flow into mixer 46. In the example shown, rotation lock 62b is a radial enlargement in receiving chamber 66. More specifically, rotation lock 62b is formed as a slot in receiver 24 that is open at the first end of receiver 24. Rotation lock 62b is formed in a first portion of receiving chamber 66 extending axially into mount body 64 from an opening through which mixer 46 enters into receiving chamber 66.

Receiver 24 is mounted to plural component sprayer 10 to move axially along axis AA. Receiver 24 is configured to connected to and at least partially receive mix chamber assembly 22 to mount mix chamber assembly 22 to plural component sprayer 10. Receiver 24 facilitates mounting of mix chamber assembly 22 to plural component sprayer 10 and dismounting of mix chamber assembly 22 from plural component sprayer 10 without requiring disassembly of or manipulation of other components of plural component sprayer 10. Receiver 24 can be considered to form a universal chamber that can interface with mix chambers 46 having different and various configurations. Receiver 24 thereby facilitates quickly and efficiently changing the configuration of a plural component sprayer 10 to generate different patterns and to spray materials having different configurations and at different pressures.

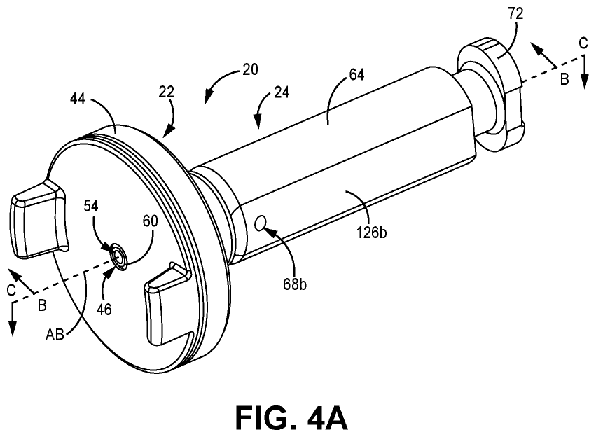

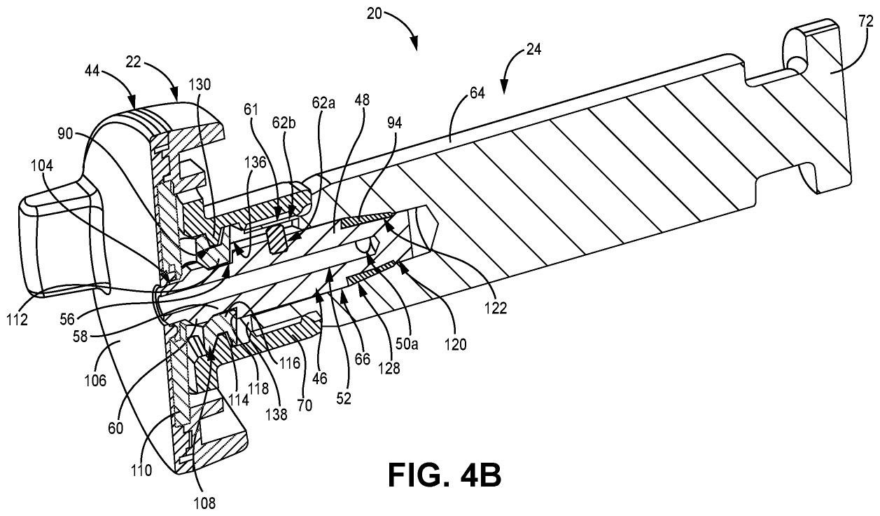

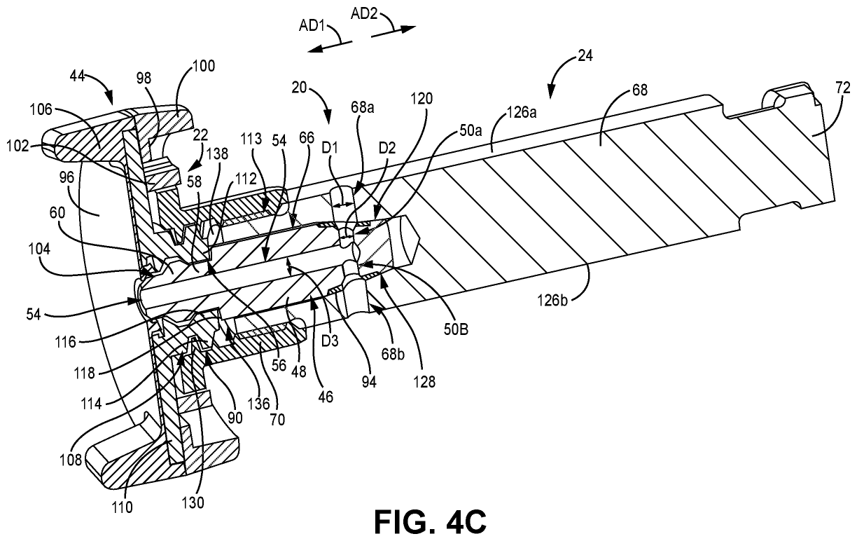

FIG. 4A is an isometric view of spray control assembly 20. FIG. 4B is a cross-sectional view of spray control assembly 20 taken along line B-B in FIG. 4A. FIG. 4C is a cross-sectional view of spray control assembly 20 taken along line C-C in FIG. 4A. FIGS. 4A-4C will be discussed together. Mix chamber assembly 22 is mounted to receiver 24 to form spray control assembly 20. Mix chamber assembly 22 is removably connected to receiver 24. Mix chamber assembly 22 can be installed on and removed from receiver 24 without manipulating any other components of a plural component sprayer 10.

Mix chamber assembly 22 is fixed to receiver 24 at locking interface 90. In the example shown, the locking interface 90 is formed by an interface between air cap 44 and cap retainer 70. Even more specifically, the locking interface 90 is a threaded interface between the cap threads 114 on mount end 112 and the retainer threads 130 on cap retainer 70. While mixer 46 and air cap 44 are shown as assembled together to form mix chamber assembly 22, it is understood that mixer 46 can be assembled to receiver 24 and operated as a mixer without the use of air cap 44. It is further understood that air cap 44 can be utilized in association with mixers and sprayers other than those shown, including use with integrated mixers that are accessible only by removing portions of the body and structure of sprayer 10 to access such integrated mixers, such as examples where mixers and receivers are formed as a single component.

The locking interface 90 is formed such that air cap 44 biases mixer 46 in the second axial direction AD2 and into sealing engagement within receiving chamber 66. Mix chamber assembly 22 shifts in second axial direction AD2 as locking interface 90 is engaged, due to the interfaced threading in the example shown. Mount end 112 interfaces with shoulder 118 of mixer 46 to exert the axial driving force on mixer 46. Gap 136 is formed axially between mount end 112 and receiver 24. Gap 136 is formed about mixer 46 and disposed axially between mount end 112 and the distal face of mount body 64. Gap 136 is formed between mix chamber assembly 22 and receiver 24 to allow movement of air cap 44 towards receiver 24. Gap 136 prevents contact between mount end 112 and the face 138. As such, axial movement of mixer 46 into receiving chamber 66 is not limited by air cap 44. In some examples, mixer 46 is sized to limit axial movement of mixer 46 into receiving chamber 66, as discussed in more detail below. Gap 136 being formed with mixer 46 fully mounted facilitates formation of the tight sealing interface between mixer 46 and receiver 24 within receiving chamber 66.

Mixer 46 is at least partially disposed within receiving chamber 66 with mix chamber assembly 22 mounted to mixer 46. In the example shown, mixer 46 is restricted to axial movement within receiving chamber 66. Rotation lock 62a interfaces with rotation lock 62b to prevent rotation of mixer 46 within receiving chamber 66. In the example shown, rotation lock 62a is a projection disposed within the slot forming rotation lock 62b. Rotation lock 62a is axially slidable within rotation lock 62b and the interface therebetween prevents rotation lock 62a from shifting circumferentially out of rotation lock 62b. In some examples, the interface between rotation lock 62a and rotation lock 62b can be configured to limit the distance that mixer 46 can shift axially into receiving chamber 66. For example, rotation lock 62a interfacing with the closed end of the slot forming rotation lock 62b can limit the distance that mixer 46 can shift in axial direction AD2 within receiving chamber 66.

Seal head 120 of mixer 46 is at least partially disposed within contoured chamber 128 portion of receiving chamber 66. The contouring of seal head 120 and contoured chamber 128 facilitates a tight fit between mixer 46 and receiver 24 within receiving chamber 66. In the example shown, seal head 120 and contoured chamber 128 have complimentary conical surfaces. As such, seal head 120 and contoured chamber 128 both narrow towards axis AB annularly around axis AB. It is understood, however, that seal head 120 and contoured chamber 128 can be of any complimentary configurations suitable for seating mixer 46 within receiving chamber 66 and forming a tight fit therebetween. For example, seal head 120 and contoured chamber 128 can each be wedge shaped with one sloped surface or two, or more, opposing surfaces converging towards axis AB. Chamber seal 94 engages mixer 46 (e.g., within seal recess 122) and the surface of receiver 24 defining contoured chamber 128 to provide a fluid-tight seal therebetween. The openings that extend through chamber seal 94 are aligned with feed bores 68a, 68b and inlet bores 50a, 50b due to mixer 46 being limited to axial sliding movement during mounting.

In the example shown, feed bores 68a, 68b through receiver 24 have first diameters D1. Inlet bores 50a, 50b have second diameters D2. In the example shown, diameters D1 are larger than diameters D2. Feed bores 68a, 68b can be sized the same as or larger than a largest diameter of inlet bores 50a, 50b across various mix chambers 46. For example, the diameters of the inlet bores 50a, 50b of a first mixer 46 can be smaller than the diameters of the inlet bores 50a, 50b of a second mixer 46. The varying diameters of the inlet bores 50a, 50b of different mix chambers 46 can facilitate generating different sprays having different spray properties while spraying at different pressures or with different material compositions. For example, larger inlet bores 50a, 50b can be used for higher pressure spraying and smaller inlet bores 50a, 50b can be used for lower pressure spraying. The feed bores 68a, 68b are sized larger or the same as inlet bores 50a, 50b such that inlet bores 50a, 50b are the passages that restrict flow through mixer 46, rather than the upstream feed bores 68a, 68b restricting the flow. As such, different mix chambers 46 can be mounted to the same receiver 24 to change the spray configuration of a single plural component sprayer 10.

Mix bore 52 has a diameter D3 that is larger than the diameter D2 of inlet bores 50a, 50b. In some examples, the diameter D3 of mix bore 52 is about 1.6 times larger than the diameters D2 of inlet bores 50a, 50b, though it is understood that other relative sizes are possible. For example, inlet bores 50a, 50b can be about 0.043 inches (about 1.09 millimeters) in diameter and mix bore can be about 0.069 inches (about 1.75 millimeters) in diameter. In some examples, the orifice 54 is circular and has a smaller diameter than mix bore 52. For example, orifice 54 can be about 0.06 inches (about 1.52 millimeters) in diameter. The diameter of orifice 54 can be about 1.4 times larger than the diameters of inlet bores 50a, 50b.

Mixer 46 shifts axially relative to receiver 24 and along axis AB during mounting and dismounting of mix chamber assembly 22. During mounting, mixer 46 is aligned with receiving chamber 66 along axis AB. Rotation lock 62a is aligned with rotation lock 62b such that the projection forming rotation lock 62a can pass into the slot forming rotation lock 62b. The anti-rotation interface formed by rotation locks 62a, 62b properly aligns inlet bores 50a, 50b with feed bores 68a, 68b, respectively, to ensure material flow into mixer 46.

Mix chamber assembly 22 is shifted axially such that mixer 46 enters into receiving chamber 66. The locking interface 90 between mix chamber assembly 22 and receiver 24 is engaged. In the example shown, air cap 44 is rotated in a first rotational direction on axis AB (e.g., one or clockwise and counterclockwise) to engage cap threads 114 with retainer threads 130. Air cap 44 rotates on and relative to mixer 46. More specifically, mount extension 116 of air cap 44 rotates within annular recess 56. The locking interface 90 can be configured to be formed (e.g., such that mixer 46 is fully installed within receiving chamber 66) and broken (e.g., such that cap threads 114 are disengaged from retainer threads 130) by less than a full rotation about axis AB. In some examples, the locking interface 90 can be formed and broken by a half turn, a quarter turn, or other rotational amounts. Having the locking interface 90 be configured for less than a full rotation facilitates simple and quick removal of mix chamber assembly 22 and installation of mix chamber assembly 22.

The engagement between rotation lock 62a and rotation lock 62b prevents rotation of mixer 46 on axis AA while air cap 44 is rotated relative to mixer 46. For example, a user can grasp the outer radial edge of air cap 44 to rotate air cap 44 on axis AB. Engaging the threaded interface drives air cap 44 in second axial direction AD2, which drives mixer 46 in second axial direction AD2 and further into receiving chamber 66 due to mount end 112 engaging with shoulder 118 and exerting a driving force on mixer 46 at shoulder 118. While locking interface 90 is described as a threaded interface, it is understood that not all examples are so limited. For example, locking interface 90 can be formed by a bayonet-type connection, a quick-connect fitting (e.g., sliding sleeve and ball detents), among other types of connections. For example, a sliding sleeve can be formed at or by mount end 112 or on or by cap retainer 70. The sliding sleeve can be actuated to allow one of mount end 122 and cap retainer 70 to pass over the other and then the sleeve is returned to secure mix chamber assembly 22 to receiver 24 (e.g., by ball detents entering a slot).

Protrusions 124 pass over retainer teeth 132 and enter into retainer notches 134. Protrusions 124 being disposed in retainer notches 134 and between retainer teeth 132 can prevent undesired unthreading of mix chamber assembly 22 from receiver 24 during operation of plural component sprayer 10.

Chamber seal 94 is preloaded by the force applied to mixer 46 by air cap 44 by way of locking interface 90. In some examples, rotation lock 62a bottoms out at the axial end of rotation lock 62b when mixer 46 is fully installed within receiving chamber 66. In some examples, the interface between seal head 120 and contoured chamber 128 prevents further axial shifting of mixer 46 into receiving chamber 66 when mixer 46 is fully installed within receiving chamber 66, as discussed in more detail below.

During dismounting of mix chamber assembly 22, the locking interface 90 between mix chamber assembly 22 and receiver 24 is disengaged and mixer 46 is pulled axially in first axial direction AD1. In the example shown, air cap 44 is rotated in a second rotational direction opposite the first rotational direction (e.g., the other one of clockwise and counterclockwise) to disengage cap threads 114 from retainer threads 130. Unthreading air cap 44 from cap retainer 70 breaks the locking interface 90 to allow removal of mixer 46 from receiving chamber 66.

Mix chamber assembly 22 is pulled axially in first axial direction AD1 and out from receiving chamber 66. For example, the user can grasp the radial exterior of air cap 44 to rotate air cap 44 on axis AB. The user then pulls air cap 44 in first axial direction AD1. Mount extension 116 interfaces with retaining head 60 to exert an axial pulling force on mixer 46 to pull mixer 46 in first axial direction AD1 and out from receiving chamber 66. The mixer 46 can then be serviced and reinstalled or a different mixer 46 having the same or a different configuration can be installed in receiving chamber 66.

Mix chamber assembly 22 forms a quick-connect component that can be easily and simply installed on a plural component sprayer and removed from the plural component sprayer. Mix chamber assembly 22 facilitates simple and efficient reconfiguration of a plural component sprayer (e.g., by switching types of mix chambers 46) without requiring manipulation or removal of other components of the plural component sprayer. For example, no retaining ring or mounting head of the plural component sprayer needs to be manipulated, repositioned, or otherwise reconfigured. Mix chamber assembly 22 is removable and installable by a single actuation to break locking interface 90 and axial movement. The user can push and actuate in a single motion during installation and can actuate and pull in a single motion during removal. In the example shown, the user can install mix chamber assembly 22 by pushing axially to insert mixer 46 and twisting air cap 44 to form locking interface 90 all in a single motion. In the example shown, the user can remove mix chamber assembly 22 by twisting air cap 44 to break locking interface 90 and pulling mixer 46 axially out of receiving chamber 66 all in a single motion. Mix chamber assembly 22 can be installed by a single push and twist motion and uninstalled by a single twist and pull motion. Mix chamber assembly 22 thereby reduces downtime and facilitates more efficient and economical spray operations. Mix chamber assembly 22 further facilitates completing multiple spray operation types with a single plural component sprayer and facilitates easy reconfiguration of the plural component sprayer by simply swapping mix chamber assemblies 22 having different configurations.

The locking interface 90 can provide mechanical advantage that assists in dismounting of mixer 46 from receiving chamber 66. For example, the interface between cap threads 114 and retainer threads 130 shifts air cap 44 in first axial direction AD1 as air cap 44 is unthreaded from cap retainer 70. As air cap 44 is rotated on axis AB to unthread the locking interface 90, the air cap 44 shifts axially in direction AD1 causing mount extension 116 to engage a portion of retaining head 60 defining annular recess 56. The interface between mount extension 116 and retaining head 60 exerts an axial force on mixer 46 in first axial direction AD1. The mechanical advantage provided by locking interface 90 assists in pulling mixer 46 axially out of receiving chamber 66 by shifting mixer 46 axially while breaking the locking interface 90, further simplifying dismounting of mix chamber assembly 22.

Mixer 46 provides significant advantages in that mixer 46 can be mounted to and removed from receiver 24 as a separate and discrete component. Mixer 46 defines the mix bore 52 within which the plural component material is formed. If undesired curing occurs in the mix bore 52, mixer 46 can be removed and serviced or replaced without removal of receiver 24. Inlet bores 50a, 50b receive the individual component materials and the materials mix within mix bore 54 such that mixer 46 is the component within which any mixing occurs. Mixing does not occur in passages of receiver 24 to avoid any curing within receiver 24.

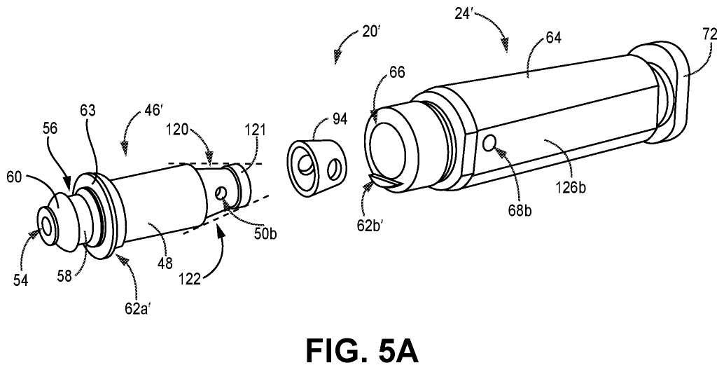

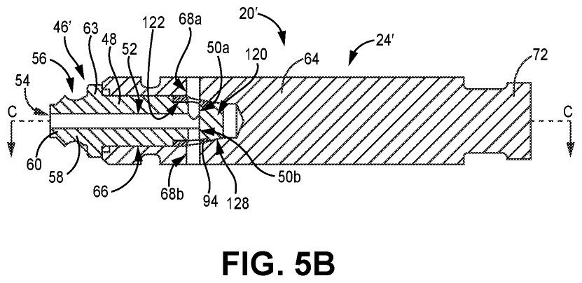

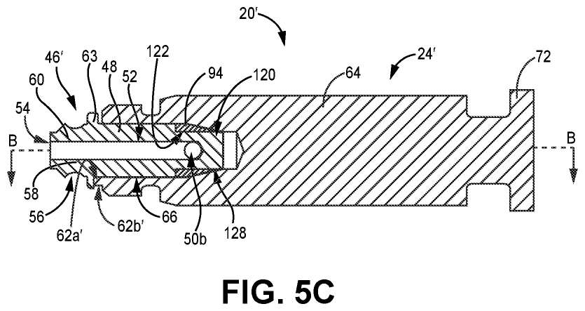

FIG. 5A is an isometric exploded view of spray control assembly 20′. FIG. 5B is a cross-sectional view of spray control assembly 20′ taken along line B-B in FIG. 5C. FIG. 5C is a cross-sectional view of spray control assembly 20′ taken along line C-C in FIG. 5B. FIGS. 5A-5C will be discussed together. Mixer 46′, receiver 24′, and chamber seal 94 of spray control assembly 20′ are shown. Mixer 46′ includes mix chamber body 48; inlet bores 50a, 50b; mix bore 52; orifice 54; annular recess 56; neck 58; retaining head 60; rotation lock 62a′; and flange 63. Mix chamber body 48 includes seal head 120. Seal recess 122 is formed in surface 121 of seal head 120. Receiver 24′ includes rotation lock 62b′; mount body 64; receiving chamber 66; feed bores 68a, 68b; and tail 72. Receiving chamber 66 includes contoured chamber 128.

Mixer 46 is substantially similar to mixer 46 (best seen in FIGS. 2A-2D). Mixer 46′ is mountable to receiver 24′ and can be dismounted from receiver 24′, which receiver 24′ is substantially similar to receiver 24 (best seen in FIGS. 3A-3C). Mixer 46′ can also be referred to as a forward element of spray control assembly 20′ and receiver 24′ can also be referred to as a rearward element of spray control assembly 20′. Spray control assembly 20′ is substantially similar to spray control assembly 20 (best seen in FIGS. 4A-4C).

Mixer 46′ is configured to mount at least partially within receiver 24′ to form spray control assembly 20′. Mixer 46′ extends between a first axial end through which orifice 54 is formed and a second axial end opposite the first axial end. Retaining head 60 is disposed at the first axial end opposite seal head 120. Neck 58 extends axially from retaining head 60 and between retaining head 60 and mix chamber body 48. Flange 63 projects radially outward relative to mix chamber body 48. Flange 63 can abut an axial face of receiver 24′ to limit the distance that mixer 46′ can move into receiver 24′. Mix chamber body 48 extends from flange 63 to the second axial end of the mixer 46′. Seal head 120 is formed proximate the second axial end of mixer 46′ and can be considered to form an upstream portion of the mix chamber body 48.

In the example shown, seal head 120 is formed as a conical portion, as generally illustrated by the dashed lines in FIG. 5A. Seal head 120 corresponds with contoured chamber 128 of receiving chamber 66 within receiver 24′. This conical geometry allows for the mixer 46′ to be compressed into the receiver 24′, thereby creating a fluid tight interface between mixer 46′ and receiver 24′, such as by chamber seal 94, to facilitate flow between feed bores 68a, 68b and inlet bores 50a, 50b, respectively. It is understood, however, that other geometries may be used other than conical, such as parabolic (not shown), to provide a compression fitting between mixer 46′ and receiver 24′. Similar to spray control assembly 20 (best seen in FIGS. 4A-4C), an air cap (e.g., air cap 44 (best seen in FIGS. 2A-2D)) or other structure may be used to secure mixer 46′ to receiver 24′ and apply force to mixer 46′ to facilitate the compressive sealing between mixer 46′ and receiver 24′.

Seal recess 122 is formed on seal head 120 of mixer 46′. Seal recess 122 extends into the sloped surface 121 of seal head 120. Chamber seal 94 is configured to mount on mixer 46′ and provide a fluid-tight seal between mixer 46′ and receiver 24′. In the example shown, chamber seal 94 is mounted on mixer 46′ and disposed within seal recess 122. Chamber seal 94 can be an elastomeric member, among other options. Chamber seal 94 can be formed as a conical sleeve, though it is understood that other shapes are possible (e.g., parabolic covering).

The interface between rotation lock 62a′ and rotation lock 62b′ prevents mixer 46′ from rotating relative to receiver 24′ while mixer 46′ is mounted to receiver 24′. In the example shown, rotation lock 62a′ is formed on flange 63 of mixer 46′. Specifically, rotation lock 62a′ is formed as a flat surface on flange 63. In the example shown, rotation lock 62a′ extends partially through the axial thickness of flange 63, though it is understood that rotation lock 62a′ can extend fully through flange 63 in other examples. Rotation lock 62b′ is formed on a projection extending axially from an axial end of receiver 24′. Rotation lock 62b′ is formed to include a flat surface that interfaces with the flat surface of rotation lock 62a′ to prevent relative rotation between mixer 46′ and receiver 24′. Rotation lock 62b′ can be considered to be a shelf that projects from receiver 24′. In addition to preventing relative rotation, rotation locks 62a′, 62b′ ensure that inlet bores 50a, 50b are aligned with feed bores 68a, 68b with mixer 46′ mounted to receiver 24′.

Feed bores 68a, 68b extend through mount body 64 to receiving chamber 66. Specifically, feed bores 68a, 68b intersect with receiving chamber 66 within the portion of the receiving chamber 66 formed by contoured chamber 128. Inlet bores 50a, 50b extend through mix chamber body 48 and to mix bore 52. In some examples, inlet bores 50a, 50b are coaxially aligned such that an axis through one inlet bore is coaxial with an axis through the other inlet bore. In some examples, inlet bore 50a is offset from inlet bore 50b, such as vertically offset. For example, inlet bores 50a, 50b may only partially overlap. The offset can be about 0.011 inches (about 0.279 millimeters), among other options. In some examples, the diameter of mix bore 52 is about 1.6 times larger than the diameters of inlet bores 50a, 50b, though it is understood that other relative sizes are possible. For example, inlet bores 50a, 50b can be about 0.043 inches (about 1.09 millimeters) in diameter and mix bore can be about 0.069 inches (about 1.75 millimeters) in diameter. Inlet bores 50a, 50b are formed through seal head 120 of mixer 46′. Inlet bores 50a, 50b extend through the sloped surface 121 of seal head 120 of mixer 46′. Mix bore 52 extends axially through mixer 46′ to orifice 54. In some examples, the orifice 54 is circular and has a smaller diameter than mix bore 52. For example, orifice 54 can be about 0.06 inches (about 1.52 millimeters) in diameter. The diameter of orifice 54 can be about 1.4 times larger than the diameters of inlet bores 50a, 50b. Feed bores 68a, 68b have larger diameters than inlet bores 50a, 50b such that inlet bores 50a, 50b are the flow restricting passages rather than feed bores 68a, 68b or mix bore 52. As such, receiver 24′ can be connected to different mixers having differently sized inlet bores 50a, 50b while providing desired flow to the mixers.

During operation, the component materials enter spray control assembly 20′ through feed bores 68a, 68b. The component materials enter mixer 46′ through inlet bores 50a, 50b and mix within mix bore 52. Openings through chamber seal 94 are aligned between feed bores 68a, 68b and inlet bores 50a, 50b to provide flowpaths therebetween while preventing leakage of the component materials. Rotation locks 62a′, 62b′ provide mistake proofing to ensure that mixer 46′ is in a desired orientation during installation such that the inlet bores 50a, 50b are aligned with the feed bores 68a, 68b. The component materials combine within mix bore 52 to form the resultant plural component material. The plural component material flows through mix bore 52 and is emitted from orifice 54. Mix bore 52 is an unobstructed passage through mixer and can be formed as a cylindrical passage, though it is understood that other configurations are possible.

Mixer 46′ can be formed from a metal or polymer. For example, mix chamber body 48; annular recess 56; neck 58; retaining head 60, rotation lock 62a′, flange 63, and seal head 120 can be formed unitarily. In some examples, mixer 46 can be formed by molding, among other options. In some examples, inlet bores 50a, 50b, mix bore 52, and orifice 54 can be formed during the molding. In some examples, mixer 46′ is formed from a polymer. In some examples, mixer 46′ can be formed from a plastic, such as a low surface energy plastic. In some examples, mixer 46′ can be formed from ultrahigh molecular weight polyethylene (UHMW-PE), polytetrafluoroethylene (PTFE), polyetheretherketone (PEEK), nylon, among other options.

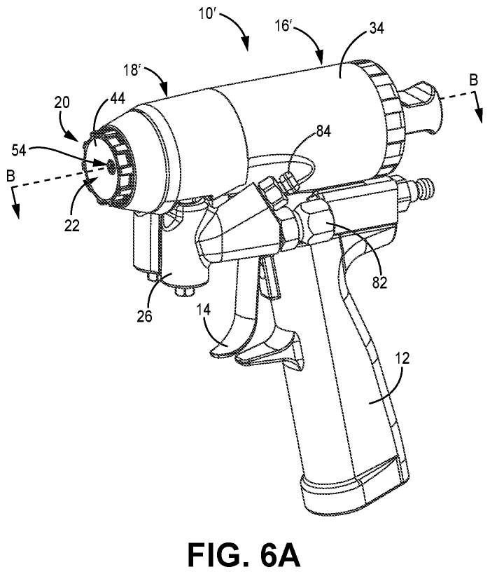

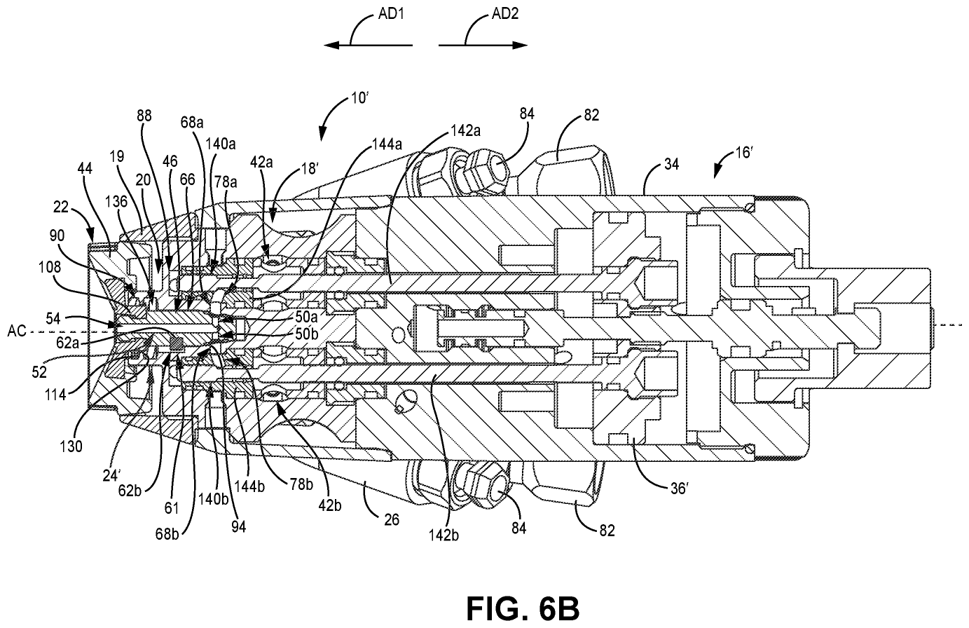

FIG. 6A is an isometric view of plural component sprayer 10′. FIG. 6B is a cross-sectional view taken along line A-A in FIG. 6B. FIGS. 6A and 6B will be discussed together. Plural component sprayer 10′ includes handle 12: trigger 14: actuator 16′; mounting head 18′: spray control assembly 20: manifold 26; retaining cap 28′: and control valves 140a, 140b. Actuator 16′ includes cylinder 34, and piston 36′. Mounting head 18′ includes material feed apertures 42a, 42b. Spray control assembly 20 includes mix chamber assembly 22 and receiver 24′. Control valves 140a, 140b respectively include needles 142a, 142b and seal cartridges 144a, 144b.

Plural component sprayer 10′ is substantially similar to plural component sprayer 10 (best seen in FIGS. 1A and 1B), except that mix chamber assembly 22 is stationary in plural component sprayer 10′ and does not shift axially as plural component sprayer 10′ is actuated between the spray and non-spray states. As such, mixer 46 can form a stationary mixer 46 in plural component sprayer 10′ while forming a dynamic mixer 46 in plural component sprayer 10. The configuration of mixer 46 facilitates use of the same mixer 46 as either a stationary or dynamic component.

Receiver 24′ is formed by a portion of mounting head 18′ in the example shown. Head cover 19 is disposed over mounting head 18′. Head cover 19 can be formed from one or more components. Head cover 19 can interface with air cap 44 to prevent undesired rotation of air cap 44. Receiving chamber 66 is formed within mounting head 18′ and defined by a portion of mounting head 18′. Receiving chamber 66 is aligned on axis AC, which can also be referred to as a spray axis. Retainer threads 130 are formed at a first axial end of receiving chamber 66. Rotation lock 62b is formed in mounting head 18′ as a slot. While receiver 24′ is described as formed by a portion of mounting head 18′, it is understood that receiver 24′ can be formed by one or more components other than mounting head 18′ that are assembled to and/or supported by mounting head 18′. Similarly, retainer threads 130 and/or rotation lock 62b can be formed by components formed separately from mounting head 18′ and can still be considered to form a portion of mounting head 18′. Receiving chamber 66 is formed such that receiving chamber 66 is stationary along axis AC during operation of plural component sprayer 10′.

Control valves 140a, 140b control flows of the first and second plural component materials to mixer 46. Needles 142a, 142b are connected to actuator 16′ to be shifted axially by actuator 16′. More specifically, needles 142a, 142b are connected to piston 36 to shift axially with piston 36. Needles 142a, 142b extend into and interface with seal cartridges 144a, 144b to control flows of the first and second component materials. Feed bores 68a, 68b are formed through a portion of mounting head 18′ and extend between and fluidly connect material feed apertures 42a, 42b and receiving chamber 66. Material feed apertures 42a, 42b are formed within mounting head 18′. Seal cartridges 144a, 144b are disposed within material feed apertures 42a, 42b, respectively. Purge chamber 88 is formed within mounting head 18′.

Needles 142a, 142b can be shifted in first axial direction AD1 to fluidly connect the material flowpaths 78a, 78b through seal cartridges 144a, 144b with the pressurized component materials in material feed apertures 42a, 42b, thereby fluidly connecting feed bores 68a, 68b with the flows of the plural component materials. Needles 142a, 142b can be shifted in second axial direction AD2 to fluidly disconnect the material flowpaths through seal cartridges 144a, 144b from the pressurized component materials, thereby stopping spraying. In some examples, needles 142a, 142b can shift in second axial direction AD2 beyond the material flowpaths 78a, 78b through seal cartridges 144a, 144b to thereby fluidly connect feed bores 68a, 68b with purge air from purge chambers 88.

Mix chamber assembly 22 mounts to plural component sprayer 10′ similar to mix chamber assembly 22 mounting to plural component sprayer 10. Mix chamber assembly 22 is aligned with receiving chamber 66 along axis AC. For example, mixer 46 is aligned with receiving chamber 66 along axis AC such that rotation lock 62a is aligned with rotation lock 62b. Mix chamber assembly 22 is shifted axially in second axial direction AD2 such that mixer 46 enters into receiving chamber 66 and rotation lock 62a interfaces with rotation lock 62b. The locking interface 90 between mix chamber assembly 22 and plural component sprayer 10′ is engaged to retain mix chamber assembly 22 on plural component sprayer 10′. In the example shown, air cap 44 is rotated on axis AC to engage the threaded interface between cap threads 114 and retainer threads 130. Engaging the locking interface 90 drives mixer 46 axially into receiving chamber 66, preloading chamber seal 94 and aligning inlet bores 50a, 50b with feed bores 68a, 68b, respectively. The anti-rotation interface between rotation locks 62a, 62b restricts mixer 46 to only axial sliding movement during mounting.

Gap 136 is formed axially between air cap 44 and receiver 24′. Gap 136 is formed about mixer 46 and disposed axially between air cap 44 and the distal face of mount body 64. Gap 136 prevents contact between air cap 44 and receiver 24′ such that axial movement of mixer 46 into receiving chamber 66 is not limited by air cap 44. Gap 136 being formed with mixer 46 fully mounted to plural component sprayer 10′ facilitates formation of the tight sealing interface between mixer 46 and receiver 24 within receiving chamber 66.

During operation, the user grasps handle 12 and actuates trigger 14 to initiate spraying by plural component sprayer 10′. Actuating trigger 14 causes compressed air to be provided to cylinder 34, which compressed air drives piston 36 in first axial direction AD1. Needles 142a, 142b shift in first axial direction AD1 to the position shown in FIG. 6B, thereby fluidly connecting material flowpaths 78a, 78b with the sources of the individual component materials. The component materials flow through material flowpaths 78a, 78b to feed bores 68a, 68b; flow through feed bores 68a, 68b to inlet bores 50a, 50b; and flow through inlet bores 50a, 50b to mix bore 52. The individual component materials combine within mix bore 52 to form the plural component material. The resultant plural component material is emitted as a spray through orifice 54.

The user stops spraying by plural component sprayer 10′ by releasing trigger 14. The compressed air is provided to cylinder 34 on an opposite side of piston 36′ to drive piston 36′ in second axial direction AD2. While actuator 16′ is pneumatically driven, it is understood that actuator 16′ can be pneumatically driven in one axial direction and mechanically driven in the opposite axial direction, such as by a spring. Needles 142a, 142b are pulled in second axial direction AD2 and fluidly disconnect the material flowpaths 78a, 78b from the individual component material sources. Needles 142a, 142b can be pulled far enough in second axial direction AD2 to uncover material flowpaths 78a, 78b and thus connect the material flowpaths 78a, 78b to the compressed purge air. The purge air can flow through material flowpaths 78a, 78b to feed bores 68a, 68b; flow through feed bores 68a, 68b to inlet bores 50a, 50b; and flow through inlet bores 50a, 50b to mix bore 52. The purge air flows through mix bore 52 and is emitted through orifice 54. The purge air is configured to clear residue from mixer 46 (e.g., from inlet bores 50a, 50b and mix bore 52) to prevent curing within mixer 46.

After spraying, the mixer 46 can be easily and quickly removed for storage or servicing or for replacement with a different mixer 46 (e.g., a second mixer 46 of the same or a different configuration). The user breaks the locking interface 90 between mix chamber assembly 22 and plural component sprayer 10′. In the example shown, the user grasps air cap 44 and rotates air cap 44 to disconnect the threaded interface between cap threads 114 and retainer threads 130. Mix chamber assembly 22 is pulled in first axial direction AD1 to remove mixer 46 from receiving chamber 66. Mixer 46 is thus dismounted from plural component sprayer 10′. The same or another mixer 46 can be mounted to plural component sprayer 10′.

Mix chamber assembly 22 provides significant advantages. Mix chamber assembly 22 can be utilized as a dynamic component or stationary component depending on the configuration of the plural component sprayer. The end user thus requires fewer components and does not need to maintain a large inventory of parts. This reduces costs to the end user. The end user can simply and quickly swap mix chamber assemblies 22 on a plural component sprayer without disassembling other components of the plural component sprayer, thereby facilitating quick and efficient changing of mixer 46. The same mix chamber assembly 22 can be utilized as a dynamic component on one plural component sprayer 10 and then utilized as a stationary component on a different plural component sprayer 10′. Mix chamber assembly 22 reduces downtime and part count, thereby increasing operational efficiency and decreasing costs.

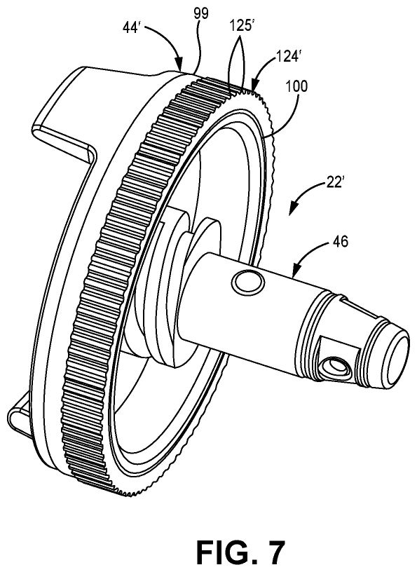

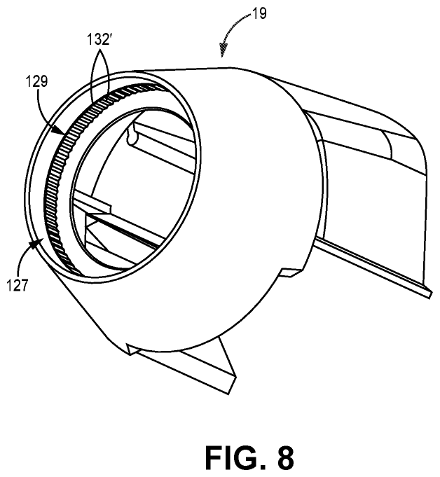

FIG. 7 is an isometric view of mix chamber assembly 22′. FIG. 8 is an isometric view of head cover 19. FIGS. 7 and 8 will be discussed together. Air cap 44′ and mixer 46 of mix chamber assembly 22′ are shown. Air cap 44′ is substantially similar to air cap 44 (best seen in FIGS. 2A-2D), except air cap 44′ includes protrusion 124′ extending from outer radial edge 99 of air cap 44′. Protrusion 124′ forms an annular array that extends fully about the periphery of the air cap 44′, in the example shown. More specifically, protrusion 124′ are formed as an annular array of cap teeth 125′ extending about the radial exterior of air cap 44′. The cap teeth 125′ are formed on outer annular projection 100 in the example shown. The cap teeth 125′ are disposed on the inner axial side of air cap 44′.

Head cover 19 is configured to be disposed over mounting head 18′ of the stationary plural component sprayer 10′ (FIGS. 6A, 6B). Front opening 127 is disposed at an end of head cover 19 and mix chamber assembly 22′ is configured to pass through front opening 127 to be installed on the plural component sprayer 10′. Locating ring 129 is formed on an inner radial surface of head cover 19 and within the front opening 127 of mounting head 18′. In the example shown, locating ring 129 is formed by an annular array of retainer teeth 132′. The retainer teeth 132′ are oriented radially inward.

Mix chamber assembly 22′ is mounted to plural component sprayer 10′ by shifting axially into and through front opening 127 along axis AC (FIG. 6B). Air cap 44′ is rotated to engage the locking interface 90 (FIG. 6B) between mix chamber assembly 22′ and receiver 24′. The textured surface of protrusion 124′ interfaces with the textured surface of locating ring 129 such that cap teeth 125′ are disposed in grooves formed between adjacent retainer teeth 132′ of locating ring 129 and retainer teeth 132′ of locating ring 129 are disposed in grooves between adjacent cap teeth 125′ of protrusion 124′. The interface between protrusion 124′ and locating ring 129 can be considered to be a toothed interface. The interface between protrusion 124′ and locating ring 129 rotationally locks air cap 44′ about axis AC to prevent air cap 44′ from rotating and loosening during operation. The interface thereby prevents undesired unthreading of mix chamber assembly 22′ from plural component sprayer 10′. The interface between protrusion 124′ and locating ring 129 also provides haptic feedback to the user during mounting and dismounting of mix chamber assembly 22′ to indicate to the user that mix chamber assembly 22′ is mounted to plural component sprayer 10′.

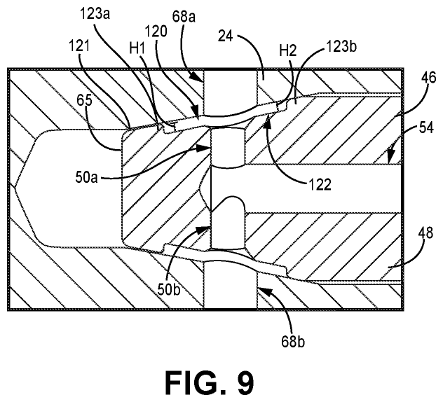

FIG. 9 is an enlarged cross-sectional view showing mixer 46 mounted within receiving chamber 66. Mix chamber body 48, inlet bores 50a, 50b, mix bore 52, seal head 120, sloped surface 121, and seal groove 122 of mixer 46 are shown. Seal groove 122 is formed axially between seal shoulder 123a and seal shoulder 123b.

Mixer 46 is mounted within receiving chamber 66 of receiver 24. While mixer 46 is shown and discussed in more detail in FIG. 9, it is understood that the discussion can apply equally to mixer 46′ (FIGS. 5A-5C). While receiving chamber 66 shown in FIG. 9 is described as being formed in receiver 24, it is understood that the discussion applies equally to a receiving chamber 66 of a receiver 24′ (shown in FIG. 6B). As discussed above, seal head 120 and contoured chamber 128 are formed with complementary slopes to facilitate compression of chamber seal 94 (best seen in FIGS. 2A, 2B, 5A) between mixer 46 and receiver 24. Chamber seal 94 is not shown in FIG. 9 for clarity.

Seal groove 122 is configured to receive chamber seal 94. With chamber seal 94 disposed in seal groove 122, chamber seal 94, or portions thereof, can extend radially outward and project beyond the surface 121 of seal head 120. The complementary contours of seal head 120 and contoured chamber 128 facilitate compression of chamber seal 94 to form the fluid-tight seal between mixer 46 and receiver 24.

Mix chamber body 48 limits the axial distance that mixer 46 can shift within receiving chamber 66. In the example shown, mix chamber body 48 is configured to interface with the wall of receiving chamber 66 to limit axial displacement of mixer 46 into receiving chamber 66. More specifically, mix chamber body 48 is configured to interface with the wall of contoured chamber 128 to limit the distance that mixer 46 can shift axially into receiving chamber 66. In the example shown, seal groove 122 is formed axially between seal shoulder 123a and seal shoulder 123b.

Seal shoulder 123b is configured to extend a further radial distance from the base of seal groove 122 than seal shoulder 123a. Seal shoulder 123a has a first wall extending height H1 away from the base of seal groove 122 to the outer surface of seal head 120. Seal shoulder 123b has a second wall extending height H2 away from the base of seal groove 122 to the outer surface of seal head 120. The height H2 is greater than the height H1. Seal shoulder 123b is axially closer to spray orifice 54 than seal shoulder 123a. The heights H1, H2 can, in some examples, be measured in a direction orthogonal to the base surface of seal recess 122 and between the base surface and a plane disposed parallel to the surface and spaced from the surface such that the plane does not extend through any portion of the seal shoulder 123a, 123b at which the height H1, H2 is measured. As such, seal shoulder 123b contacts the surface of receiver 24 defining receiving chamber 66 prior to seal shoulder 123a, thereby facilitating compression of the chamber seal 94 and providing a hard stop limiting axial displacement of mixer 46 into receiving chamber 66. In the example shown, a gap is formed between mixer 46 and the wall defining receiving chamber 66 about the portion of mixer 46 between seal shoulder 123a and the distal face 65 of mixer 46 at the second axial end of mixer 46. The gap allows for chamber seal 94 to be compressed a desired amount to form the fluid-tight seal between mixer 46 and receiver. The seal shoulder 123b limiting axial displacement prevents over-compression of the chamber seal 94 and ensures proper alignment between feed bores 68a, 68b and inlet bores 50a, 50b.

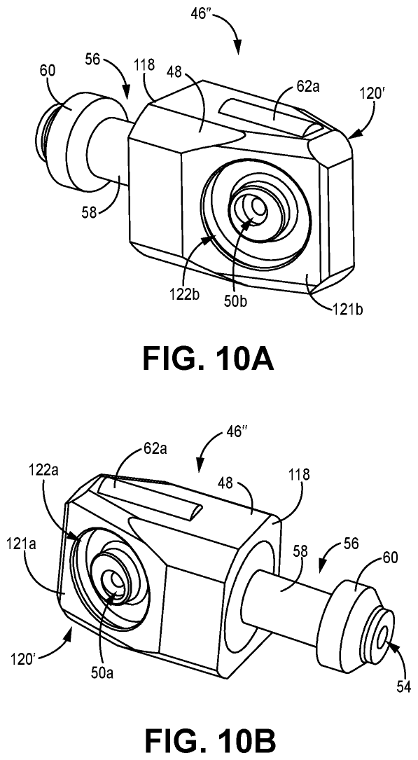

FIG. 10A is a first isometric view of mixer 46″. FIG. 10B is a second isometric view of mixer 46″. FIGS. 10A and 10B will be discussed together. Mixer 46″ is similar to mixer 46 (best seen in FIGS. 2A-2D), except mixer 46″ includes seal head 120′ formed by two converging surfaces 121a, 121b through which the inlet bores 50a, 50b extend. Seal head 120′ can be considered to be wedge shaped in the example shown. As such, the seal head of a mix chamber can be formed by at least one surface converging towards axis AB, such as the conical surface 121 of mixer 46 or the multiple surfaces 121a, 121b of mixer 46″. Mixer 46″ includes multiple seal recesses 122a, 122b each configured to receive a chamber seal (not shown) (e.g., an O-ring among other options, which can be formed from elastomer among other options) within the seal recess 122a, 122b. Mixer 46″ can be mounted to air cap 44 similar to mixer 46 (e.g., by air cap 44 threading over retaining head 60 and into annular recess 56) to form a mix chamber assembly similar to mix chamber assembly 22. While mixer 46″ is shown as including rotation lock 62a as an elongate projection, it is understood that the non-circular cross-sectional shape of seal head 120′ taken orthogonal to axis AB forms the anti-rotation component of mix chamber 26′. Rotation lock 62a can provide mistake-proofing by preventing installation of mix chamber 26′ in orientations other than the desired orientation. It is understood that some examples of mixer 46″ are configured to be installed in multiple orientations (e.g., inlet bore 50a can be aligned with either feed bore 68a, 68b).

Mixer 46″ can be formed from a metal or polymer. For example, mix chamber body 48; annular recess 56; neck 58; retaining head 60, shoulder 118, and seal head 120′ can be formed unitarily. As such, seal head 120′ can be integrally formed with mix chamber body 48. In some examples, mixer 46″ can be formed by molding, among other options. In some examples, inlet bores 50a, 50b, mix bore 52, and orifice 54 can be formed during the molding. In some examples, mixer 46″ is formed from a polymer. In some examples, mixer 46″ can be formed from a plastic, such as a low surface energy plastic. In some examples, mixer 46″ can be formed from ultrahigh molecular weight polyethylene (UHMW-PE), polytetrafluoroethylene (PTFE), polyetheretherketone (PEEK), nylon, among other options.

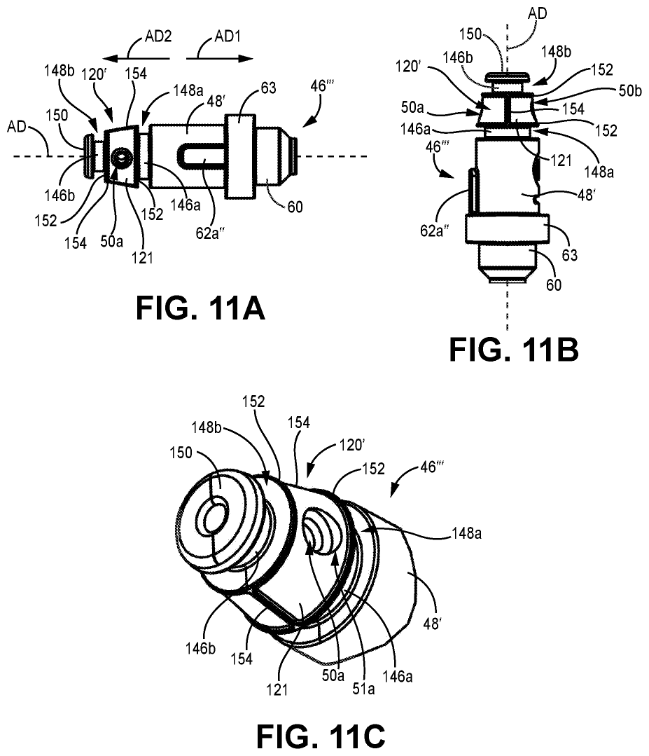

FIG. 11A is a plan view of mixer 46″. FIG. 11B is a second plan view of mixer 46″. FIG. 11C is an enlarged isometric view of the seal head 120′ of mixer 46′″. FIGS. 11A-11C will be discussed together. Mix chamber body 48; inlet bores 50a, 50b; retaining head 60; rotation lock 62a; flange 63; seal head 120′; seal necks 146a, 146b; seal recesses 148a, 148b and end cap 150 of mixer 46″ are shown. Seal head 120′ includes annular ribs 152 and axial ribs 154.

Mixer 46′″ is configured to mount within a plural component sprayer (e.g., plural component sprayer 10 (best seen in FIG. 1A) or plural component sprayer 10′ (best seen in FIG. 6A)) to receive individual component materials and combine the component materials into a plural component material for emission from the orifice of mixer 46′″ as a spray. Mixer 46′″ is substantially similar to mixer 46 (best seen in FIGS. 2A-2C), mixer 46′ (FIGS. 5A-5C), and mixer 46″ (FIGS. 10A and 10B), except that mixer 46′″ is formed as a unitary component. In some examples, mixer 46′″ is formed from a polymer. In some examples, mixer 46′″ can be formed from a plastic, such as a low surface energy plastic. In some examples, mixer 46′″ can be formed from ultrahigh molecular weight polyethylene (UHMW-PE), polytetrafluoroethylene (PTFE), polyetheretherketone (PEEK), nylon, among other options. For example, mixer 46″″ can be formed by molding, among other options.

Mixer 46′″ extends between a first axial end, through which the orifice of mixer 46′″ extends, and a second axial end at which end cap 150 is formed. Retaining head 60 is disposed at the first axial end. In the example shown, retaining head 60 extends to flange 63. It is understood, however, that some examples of mixer 46′″ can be configured with a neck, similar to neck 58 (best seen in FIGS. 2C and 2D) formed axially between retaining head 60 and mix chamber body 48′. The neck can meet with mix chamber body 48′ at flange 63. An annular recess, similar to annular recess 56 (best seen in FIGS. 2C and 2D) can be formed about the neck and axially between retaining head 60 and flange 63 to facilitate connection of mixer 46′″ and an air cap, such as air cap 44 (best seen in FIGS. 2A-2D) or air cap 44′ (FIG. 7), to form a mix chamber assembly, similar to mix chamber assembly 22 (best seen in FIGS. 4A-4C) or mix chamber assembly 22′ (FIG. 7). In some examples, retaining head 60 can include exterior threading to facilitate mounting of the air cap on the mixer 46″.

Flange 63 projects radially from mix chamber body 48′ relative to the spray axis AD of mixer 46″, along which the internal mix bore (similar to mix bore 52 (best seen in FIGS. 2C and 2D)) extends and along which mixer 46′″ emits the plural component material as a spray. Mix chamber body 48′ extends axially from an opposite axial side of flange 63 from retaining head 60. Mix chamber body 48′ extends to the second axial end of mixer 46′″. Rotation lock 62a″ is a radial projection extending from mix chamber body 48′. In the example shown, rotation lock 62a″ is axially elongate and extends along mix chamber body 48′ from flange 63 and part of the distance to seal recess 148a.

Seal neck 146a extends from an axial end of mix chamber body 48′ opposite flange 63. Seal recess 148a is formed at an axial end of mix chamber body 48′ opposite flange 63. Seal recess 148a is formed annularly about seal neck 146a. Seal head 120′ extends axially from seal neck 146a. Seal head 120′ extends axially between seal neck 146a and seal neck 146b. Seal head 120′ is cantilevered from mix chamber body 48′. Inlet bores 50a, 50b extend from openings formed through the exterior of seal head 120′. Seal neck 146b projects from an opposite axial side of seal head 120′ than seal neck 146a. End cap 150 is disposed at an opposite axial end of seal neck 146b from seal head 120′. End cap 150 is formed at an opposite axial end of mixer 46′″ from the orifice through which the plural component material is emitted. Seal recess 148b is formed annularly about seal neck 146b and axially between seal head 120′ and end cap 150.

In some examples, seal recesses 148a, 148b can receive annular seals (e.g., an O-ring among other options, which can be formed from elastomer (e.g., silicon rubber, polyurethane, etc.) among other options). The mixer 46′″ thus include first and second seal grooves 148a, 148b formed in the mix chamber body 48′ and disposed on opposite axial sides of the seal head 120′. The first and second seal grooves 148a, 148b extend fully about the axis of the mixer.

Annular ribs 152 and axial ribs 154 are formed on seal head 120′. Annular ribs 152 and axial ribs 154 project radially outward from the surface 121′ of seal head 120′. Annular ribs 152 are formed on seal head 120′ and extend circumferentially about seal head 120′. Seal head 120′ includes a set of annular ribs 152 that are disposed on opposite axial sides of inlet bores 50a, 50b. In the example shown, a first annular rib 152 is disposed axially between the inlet bores 50a, 50b and seal recess 148b and a second annular rib 152 is disposed axially between the inlet bores 50a, 50b and seal recess 148a. The openings of inlet bores 50a, 50b are disposed axially between the first and second annular ribs 152. Axial ribs 154 are formed on seal head and extend axially along seal head 120′. Axial ribs 154 are disposed circumferentially between the openings of inlet bore 50a and inlet bore 50b. In the example shown, axial ribs 154 extend axially between the two annular ribs 152 of seal head 120′. In the example shown, a first axial rib 154 is disposed between inlet bore 50a and inlet bore 50b on a first radial side of seal head 120′ and a second axial rib 154 is disposed between inlet bore 50b and inlet bore 50a on a second radial side of seal head 120′. The first and second axial ribs 154 can be disposed 180-degrees apart about seal head 120′, though it is understood that other offsets are possible. The first and second axial ribs 154 are disposed on opposite circumferential sides of inlet bore 50a relative to each other. The first and second axial ribs 154 are disposed on opposite circumferential sides of inlet bore 50b relative to each other.

Mixer 46′″ is configured as a unitary mixer 46′″ and does not include a separate sealing element mounted on mixer 46″, in the example shown. Mixer 46′″ is configured to be installed on a receiver in a similar manner to mixer 46. Mixer 46′″ is shifted axially in second axial direction AD2 into the receiver and the seal head 120′ encounters the surface defining the contoured chamber portion (e.g., contoured chamber 128 (best seen in FIG. 3B)) of the receiver. The annular ribs 152 and axial ribs 154 are configured to deform due to the pressure exerted on annular ribs 152 and axial ribs 154 by the interface between the converging surfaces of seal head 120′ and of the contoured chamber of the receiver. The axial ribs 154 and annular ribs 152 can also be referred to as crush ribs.

The deformed axial ribs 154 conform to the interior surface forming the contoured chamber, forming a fluid-tight seal between seal head 120′ and the interior surfaces of the contoured chamber. The fluid-tight seal formed by axial ribs 154 prevents the component materials from flowing about the exterior of mixer 46′″ and mixing together about the exterior. The axial ribs 154 limit circumferential flow of the component materials about the mixer 46″. The component materials are limited to flowing through the inlet bores 50a, 50b to mix within the mix bore 52 of mixer 46″. The deformed annular ribs 152 conform to the interior surface forming the contoured chamber, forming a fluid-tight seal between seal head 120′ and the interior surfaces of the contoured chamber. The fluid-tight seal formed by annular ribs 152 prevents the component materials from flowing about the exterior of mixer 46′″ and mixing together about the exterior. Annular ribs 152 limit axial flow of the component materials. The component materials are limited to flowing through inlet bores 50a, 50b to mix within the mix bore 52 of mixer 46″. While mixer 46′″ is discussed as including both axial ribs 154 and annular ribs 152, it is understood that some examples may include only axial ribs 154. For example, seals mounted within seal recesses 148a, 148b can provide adequate sealing to prevent axial flow while axial ribs 154 limit circumferential flow. Such an example may not include annular ribs 152. Some examples of mixer 46′″ include annular ribs 152 and include seals mounted within seal recesses 148a, 148b.

Mixer 46′″ provides significant advantages. Mixer 46′″ can be formed as a single, unitary component that is mountable to and dismountable from a plural component sprayer. In some examples, mixer 46′″ can be formed by molding. Mixer 46′″ can thus be simply and quickly manufactured. Mixer 46′″ can also be connected to an air cap to form a quick connect, spray control assembly that can be quickly and easily mounted to and dismounted from a plural component sprayer. Mixer 46′″ can be formed by molding as the unitary component and can be formed from polymer. Mixer 46′″ can be formed from plastic. In some examples, mixer 46′″ can be formed from UHMW-PE, PTFE, PEEK, nylon, among other options. Mixer 46′″ can be formed from a low surface energy plastic. Such a configuration reduces costs relative to metallic mixers and can simplify the manufacturing process.

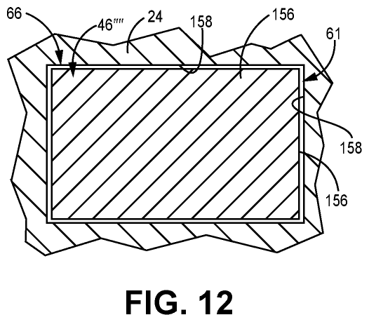

FIG. 12 is a cross-sectional view showing anti-rotation interface 61 between mixer 46″″ and receiver 24. The anti-rotation interface 61 is formed by contoured surfaces formed by exterior surfaces 156 of mixer 46″″ and by interior surfaces 158 of receiver 24 that define receiving chamber 66. In the example shown, exterior surfaces 156 form a polygonal cross-section (rectangular in the example shown) and interior surfaces 158 similarly form a polygonal cross-section (rectangular in the example shown). It is understood that exterior surfaces 156 and interior surfaces 158 can be of any desired shape suitable for forming a cross-section that prevents rotation of mixer 46′″ within receiving chamber 66 and relative to receiver 24 (e.g., oval, triangular, square, rectangular, pentagonal, among other non-circular options). The anti-rotation interface 61 prevents rotation of mixer 46″″ to ensure proper alignment between inlet bores 50a, 50b and feed bores 68a, 68b.

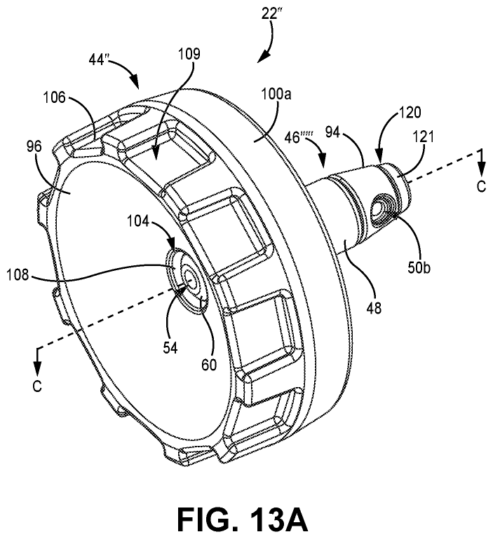

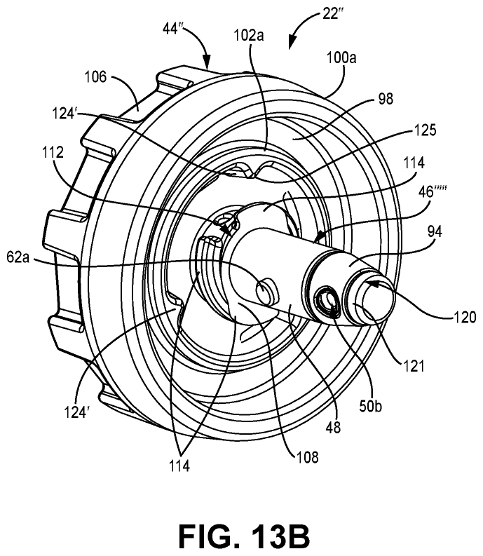

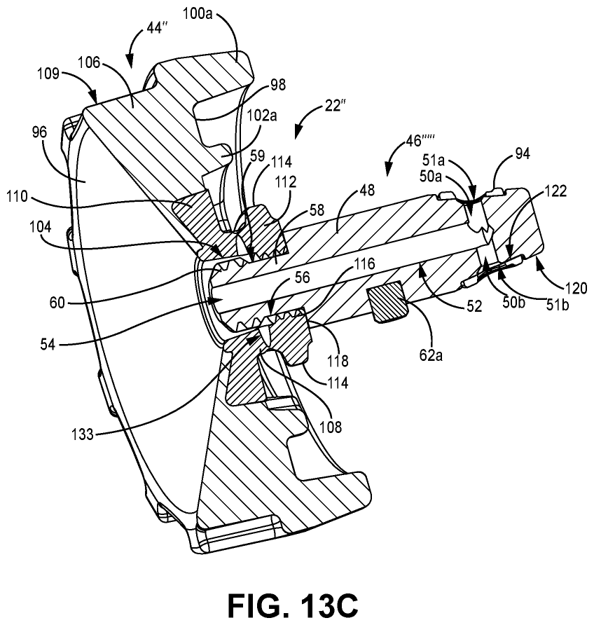

FIG. 13A is a first isometric view of mix chamber assembly 22″. FIG. 13B is a second isometric view of mix chamber assembly 22″. FIG. 13C is a cross-sectional view of mix chamber assembly 22″ taken along line C-C in FIG. 13A. FIGS. 13A-13C will be discussed together. Mix chamber assembly 22″ includes air cap 44″, mixer 46′″, and chamber seal 94. Air cap 44″ includes outer axial side 96, inner axial side 98, annular projection 100a, annular projection 102a, cap opening 104, cap body 106, and mount 108. Annular projection 102a includes protrusions 124. Mount 108 includes cap end 110, mount end 112, cap threads 114, and mount extension 116. Mixer 46′″″ includes mix chamber body 48; inlet bores 50a, 50b; mix bore 52; orifice 54; annular recess 56; neck 58; retaining head 60; and rotation lock 62a. Mix chamber body 48 includes shoulder 118 and seal head 120. Seal recess 122″ is formed in surface 121 of seal head 120.

Mix chamber assembly 22″ is substantially similar to mix chamber assembly 22′ and mix chamber assembly 22. It is understood that examples are similar to each other and that detail referenced in connection with one embodiment either is present in the other example or can be present in the other example. As such, all aspects between examples can be assumed to be the same unless shown and/or described to be clearly different such that the descriptions and drawings for one example are applicable to the other example. Various common aspects are not repeated between examples for brevity.

Mix chamber assembly 22″ is configured to receive individual component materials, mix the individual component materials to form a plural component material, and emit the plural component material as a spray. Air cap 44″ is mounted to mixer 46′″″ to form mix chamber assembly 22″. In the example shown, air cap 44″ is formed by cap body 106 being disposed on mount 108. Mount 108 of air cap 44″ connects air cap 44″ to mixer 46′″″. Cap opening 104 extends axially through air cap 44″. Mixer 46′″″ extends into and at least partially through cap opening 104. In the example shown, cap opening 104 is formed through mount 108. Mixer 46′″″ is oriented on axis AB, which can be referred to as the mix chamber axis. Axis AB can be coaxial with the spray axis AA (FIGS. 1A and 1B).

Outer axial side 96 of air cap 44″ is configured to be oriented in first axial direction AD1 (FIGS. 1B and 1C) with mix chamber assembly 22″ mounted to a plural component sprayer. Outer axial side 96 is oriented out of plural component sprayer 10. Outer axial side 96 includes a frustoconical surface extending radially away from cap opening 104 and in first axial direction AD1. Inner axial side 98 of air cap 44″ is configured to be oriented in second axial direction AD2 (FIGS. 1B and 1C) with mix chamber assembly 22″ mounted to a plural component sprayer. Inner axial side of air cap 44″ is oriented towards plural component sprayer 10. Annular projection 100a extends in second axial direction AD2 and projects axially relative to axial side 98. Annular projection 100a is formed at an outer radial side of air cap 44″ as part of cap body 106.

Grip 109 is formed by cap body 106. Grip 109 is formed as an annular axial projection, in the example shown. Grip 109 extends axially outward away from the annular projections 100a, 100b. In the example shown, grip 109 is spaced radially inward from an outer radial edge of cap body 106. Annular projection 100a is configured to interface with cap seal 92 while in the spray state (shown in FIG. 1B). Annular projection 102a extends in second axial direction AD2. Annular projection 102a extends from inner axial side 98 of air cap 44″. In the example shown, annular projection 102a extends a shorter axial distance than annular projection 100a.

Annular projection 100a projects axially in second axial direction AD2 and retains air in the sprayer 10 during spraying, preventing interference with the spray pattern, and allows discharge of air over the radial exterior of air cap 44″ to clean air cap 44″ when sprayer 10 is not spraying. Annular projection 100a extends in the second axial direction AD2 from the second axial side 98 of cap body 106, opposite the first axial side 96 of cap body 106, such that the mount 108 is at least partially radially overlapped by the annular projection 100a. The annular projection 100a is disposed at an outer radial edge of the cap body 106. Annular projection 102a extends in the second axial direction AD2 from the second axial side 98 of cap body 106, opposite the first axial side 96 of cap body 106, such that the mount 108 is at least partially radially overlapped by the inner annular projection 102a.

Protrusions 124 are disposed on inner axial side 98 of air cap 44″ and extend radially inward towards axis AB. It is understood, however, that while protrusions 124 are shows as connected to inner axial side 98 and annular projection 102a, in some examples, protrusions 124 can extend from only one of annular projection 102a and inner axial side 98. In the example shown, air cap 44″ includes multiple protrusions 124, three in the example shown, though it is understood that air cap 44″ can include as many or as few protrusions 124 as desired. For example, air cap 44″ can include one, two, three, four, or more protrusions 124. In the example shown, each protrusion 124 is formed as a single tooth 125 Air cap 44″ includes an annular array of protrusions 124 in the example shown. Protrusions 124 are configured to interface with a portion of plural component sprayer 10 (e.g., the exterior of cap retainer 70) to prevent rotation of air cap 44″ about axis AB with mix chamber assembly 22″ mounted to plural component sprayer 10. In some examples, however, air cap 44″ may not include protrusions 124, as discussed in more detail below.

Mount 108 projects in second axial direction AD2 relative to inner axial side 98 of air cap body 10644″. Mount 108 is configured to interface with mixer 46′″″ to connect air cap 44″ and mixer 46′″″ to form mix chamber assembly 22″. Mount 108 is further configured to connect with a portion of plural component sprayer 10 to mount mix chamber assembly 22″ to plural component sprayer 10. Cap opening 104 extends fully through mount 108 along axis AB. Cap end 110 of mount 108 interfaces with cap body 106. In the example shown, cap body 106 is overmolded on cap end 110. Mount end 112 is an opposite axial end of mount 108 from cap end 110. Mount end 112 is configured to interface with both mixer 46′″″ and plural component sprayer 10. Recess 133 is formed between cap end 110 and mount end 112 of mount 108. Recess 133 allows the threaded end of mount 108 to flex relative to the portion interfacing with cap body 106. Flexing allows portions of cap opening 104 to flex and displace such that the portions are not disposed coaxially. The cap opening 104 is sized such that air cap 44 can be displaced relative to mixer 46 (e.g., if sprayer 10 is dropped) without bending mixer 46, thus protecting mixer 46 from undesired radial force. Recess 133 can be formed as a continuous ring about the axis AB or as a series of slots annularly about the axis AB. In some examples, one or more, up to all, of the recesses 133 are radially aligned with projections 124. One or more of projections 124 can be disposed to radially overlap one or more of the recesses 133. The recesses 133 can allow cap body 106 to bend relative to mount end 112 to facilitate projection 124 passing over mating teeth on the sprayer and falling into trenches between the teeth.

Mount 108 can be formed from durable polymer or a metal, among other options. Cap body 106 can be overmolded onto mount 108, among other connection options. For example, cap body 106 can be formed by a low surface energy (LSE) plastic, among other options. In the example shown, cap body 106 connects to cap end 110 of mount 108. For example, cap end 110 can include a radially extending flange that cap body 106 is overmolded onto. It is understood that, in some examples, air cap 44″ can be manufactured as a single component.

Cap threads 114 are formed on mount end 112 of mount 108. Cap threads 114 form exterior threading on mount end 112 in the example shown. Cap threads 114 are configured to interface with a component of plural component sprayer 10 to mount mix chamber assembly 22″ to plural component sprayer 10. Mount extension 116 is formed on mount end 112 of mount 108. In the example shown, mount extension 116 is a radial projection extending radially inward towards axis AB. Mount extension 116 can be annular and extend fully around axis AB. Mount extension 116 is configured to be disposed within annular recess 56 with air cap 44″ mounted to mixer 46′″. Mount extension 116 can also be referred to as an inner radial extension.

Mount extension 116 can be configured to pass over retaining head 60 and into annular recess 56 to mount air cap 44″ to mixer 46′″. In some examples, mount extension 116 includes interior threading on a radially inner side of mount extension 116. Retaining head 60 can include complementary exterior threading to the threading of mount extension 116. The interfaced threading between mount extension 116 and retaining head 60 facilitates air cap 44″ mounting to mixer 46′″. For example, mount extension 116 can be threaded over retaining head 60 until mount extension 116 enters into annular recess 56. The threading is disengaged with mount extension 116 disposed within annular recess 56. As such, mount extension 116 can include both first threads formed on an exterior side of mount 108 (e.g., cap threads 114) and second threads formed on an interior side of mount 108 (e.g., on mount extension 116).

Mount extension 116 is sized such that mount extension 116 interfaces with retaining head 60 to prevent air cap 44″ from being pulled axially off of mixer 46″. In the example shown, retaining head 60 is disposed at the axial-most end of a spray end extension from the mix chamber body 48. As such, the interface between mount extension 116 and retaining head 60 prevents air cap 44″ from being pulled in first axial direction AD1 off of mixer 46″. It is understood, however, that air cap 44″ can mount to mixer 46′″″ in any desired manner. For example, mount extension 116 can be formed from or include a compliant material that is compressed in reaction to retaining head 60 passing through cap opening 104 and expands into annular recess 56 after passing over retaining head 60, among other mounting options.

Retaining head 60 is disposed at a first axial end of mixer 46′″″ and seal head 120 is formed at a second axial end of mixer 46′″″ opposite retaining head 60. Neck 58 extends between and connects mix chamber body 48 and retaining head 60. Retaining head 60 is radially larger than neck 58 and mix chamber body 48 is radially larger than neck 58. In some examples, retaining head 60 can be considered to have a larger diameter than neck 58. In some examples, mix chamber body 48 can be considered to have a larger diameter than neck 58. Annular recess 56 is formed about neck 58 and is disposed axially between retaining head 60 and mix chamber body 48.

Shoulder 118 is formed at an opposite axial end of annular recess 56 from retaining head 60. In the example shown, shoulder 118 is formed by a portion of mix chamber body 48 projecting radially outward relative to neck 58. Shoulder 118 can be considered to form an axial-most end of mix chamber body 48 opposite seal head 120. Shoulder 118 can be formed as a planar face oriented orthogonal to axis AB. Mount end 112 of mount 108 of air cap 44″ is configured to interface with shoulder 118 with mix chamber assembly 22″ mounted to plural component sprayer 10. Air cap 44″ can exert a driving force on mixer 46′″″ by mount end 112 interfacing with shoulder 118. The axial driving force biases mixer 46′″″ in second axial direction AD2 and into receiving chamber 66 to seat mixer 46′″″ and to preload chamber seal 94.

Seal head 120 is disposed at an opposite axial end of mixer 46“ ” from neck 58. The surface 121 of seal head 120 is contoured to facilitate a tight fit within plural component sprayer 10. In the example shown, seal head 120 is frustoconical and surface 121 narrows towards the distal end of mix chamber body 48. While seal head 120 is shown including a smoothly contoured single surface 121, seal head 120 can be include multiple surfaces converging towards axis B. Seal recess 122″ extends annularly about mix chamber body 48. Seal recess 122″ is a depression extending into mix chamber body 48. In the example shown, seal recess 122″ is formed on seal head 120. Chamber seal 94 is disposed within seal recess 122″. Chamber seal 94 extends annularly about mixer 46′″″. Chamber seal 94 is disposed about an inlet opening of the first inlet bore 50a and the chamber seal 94 is disposed about an inlet opening of the second inlet bore 50b. Chamber seal 94 can be a polymeric seal, among other options. The outer surface of chamber seal 94 is contoured to narrow in second axial direction AD2 similar to seal head 120. Flow openings extend through chamber seal 94 to provide flowpaths through chamber seal 94, allowing flow through chamber seal 94 between feed bores 68a, 68b and inlet bores 50a, 50b.

Rotation lock 62a extends radially from mixer 46″ to interface with a portion of plural component sprayer 10 to restrict mixer 46′″″ to linear movement during installation on and removal from plural component sprayer 10. Rotation lock 62a limits mixer 46′″″ to axial movement to ensure proper alignment of inlet bores 50a, 50b to receive the individual component materials. 46′″″

Inlet bores 50a, 50b extend into mixer 46′″″ and provide flowpaths for the individual component materials to enter into mixer 46′″″. Each inlet bore 50a, 50b extends to and intersects with mix bore 52. Mix bore 52 extends axially through mixer 46′″″ to orifice 54. Mix bore 52 extends within each of mix chamber body 48, neck 58, and retaining head 60. The individual component materials mix within mix bore 52 to form the plural component material that is emitted through orifice 54 as a spray.

Mix chamber assembly 22″ is mountable to and removable from a plural component sprayer 10 as a single component. Outer axial side 96 of air cap 44″ is conical in the example shown. The conical configuration can direct the spray emitted through air cap 44″. Air cap 44″ can mount to and dismount from multiple different configurations of sprayers and mixers. Grip 109 facilitates easy grasping at a location spaced axially and radially relative to orifice 54, preventing inadvertent contamination of orifice 54 by the user while manipulating air cap 44″. Mount 108 facilitates misaligned mounting of air cap 44 on sprayer 10. Recess 133 allows cap body 108 to bend relative to the axis of mix bore 52 without air cap 44 interfering with the spray emitted from orifice 54.

### Discussion of Non-Exclusive Examples

The following are non-exclusive descriptions of possible examples of the present invention.

A mixer configured for a plural component sprayer includes a mix chamber body, a mix bore extending along an axis through the mix chamber body, where an outlet orifice is formed at a distal end of the mix bore, and a first inlet bore extending through the mix chamber body to the mix bore. The mixer can additionally include a second inlet bore extending through the mix chamber body to the mix bore, a retaining head disposed at a first axial end of the mixer, the mix bore extending through the retaining head, and a seal head disposed at a second axial end of the mixer opposite the first axial end, wherein the seal head has an exterior surface that converges towards the axis.

The mixer of the preceding paragraph can optionally include, additionally and/or alternatively, any one or more of the following features, configurations and/or additional components:

The first inlet bore and the second inlet bore extend through the seal head.

The seal head is conical.

The seal head is formed as a wedge shape and the exterior surface includes at least two exterior surfaces.

A seal groove is formed on the seal head, the seal groove extending into the exterior surface and configured to receive a chamber seal.

The seal groove extends annularly about the axis.

A first seal shoulder is formed at a first axial end of the seal groove and a second seal shoulder is formed at a second axial end of the seal groove, the second seal shoulder projecting further radially from a base of the seal groove than the first seal shoulder.

A first rotation lock is formed on the mix chamber body, the first rotation lock configured to interface with a second rotation lock of the plural component sprayer to prevent the mixer from rotating about the axis.

The first rotation lock is a projection extending outward from the mix chamber body.

A neck extending between and connecting the retaining head and the mix chamber body, the retaining head extending further from the axis than the neck.

The mix chamber body extends radially outward relative to the neck and the retaining head at an end of the neck opposite the retaining head.

The first inlet bore has a first diameter, the mix bore has a second diameter, and the second diameter is larger than the first diameter.

The retaining head includes exterior threading.

A first axial rib projecting from the exterior surface of the seal head and extending axially along the seal head, the first axial rib disposed circumferentially between the first inlet bore and the second inlet bore and a second axial rib projecting from the exterior surface of the seal head and extending axially along the seal head, the first axial rib disposed circumferentially between the first inlet bore and the second inlet bore, wherein the first axial rib is disposed on an opposite circumferential side of the first inlet bore from the second axial rib.

A first annular rib projecting from the exterior surface of the seal head and extending annularly about the seal head and a second annular rib projecting from the exterior surface of the seal head and extending annularly about the seal head, the second annular rib disposed on an opposite axial side of the first inlet bore from the first annular rib.

A first seal neck extending between the mix chamber body and a first axial end of the seal head, a second seal neck extending from a second axial end of the seal head opposite the first axial end of the seal head, a first seal recess formed annularly about the first seal neck and axially between the mix chamber body and the seal head, and a second seal recess formed annularly about the second seal neck and at least partially axially defined by the seal head.

A mix chamber assembly for use in a plural component sprayer includes an air cap having a central opening therethrough, a mixer mounted to the air cap and at least partially disposed within the central opening. The mixer includes a mix chamber body, a mix bore extending along an axis through the mix chamber body, wherein an outlet orifice is formed at a distal end of the mix bore, a first inlet bore extending through the mix chamber body to the mix bore, and a second inlet bore extending through the mix chamber body to the mix bore.

The mix chamber assembly of the preceding paragraph can optionally include, additionally and/or alternatively, any one or more of the following features, configurations and/or additional components:

The mixer includes a first rotation lock configured to interface with a receiver of the plural component sprayer to prevent rotation of the mixer on the axis.

The first rotation lock is formed by one of a projection extending from the mixer and a slot formed in the mixer.

The mixer further includes a neck extending from a first axial end of the mix chamber body, a retaining head disposed at an end of the neck such that the neck extends between and connects the retaining head and the mix chamber body, wherein the mix bore extends through the neck and the retaining head, and wherein an annular recess is formed about the neck and axially between the retaining head and the mix chamber body.

The retaining head includes first threads and the air cap includes second threads formed in the central opening.

The air cap includes a mount extension at least partially disposed within the annular recess.

The retaining head is sized such that an interface between the retaining head and the mount extension prevents the mount extension from passing axially over the retaining head and out of the annular recess in an axial direction away from the mix chamber body.

The air cap is rotatable about the axis and relative to the mixer with the mount extension disposed in the annular recess.

A second axial end of the mix chamber body is contoured such that at least one surface of the mix chamber body is angled towards the axis.

The at least one surface is conical.

The second axial end is frustoconical.

A chamber seal is disposed on the at least one surface.

The chamber seal is disposed about an inlet opening of the first inlet bore and the chamber seal is disposed about an inlet opening of the second inlet bore.

The at least one surface comprises a first surface and a second surface.

The mixer further includes a shoulder disposed at the first axial end and extending radially outward relative to the neck.

The shoulder includes a planar interface surface disposed orthogonal to the axis.

The air cap includes a mount and an air cap body extending radially outward from the mount, and wherein the mount includes a mount end disposed at least partially around the neck.

An inner radial extension of the mount is disposed within the annular recess.

The mount end includes first threads formed on an outer radial side of the mount.

The mount end includes second threads formed on an inner radial side of the mount.

A spray control assembly includes any of the foregoing mix chamber assemblies, and a receiver defining a receiving chamber, the receiver supporting the mix chamber assembly, wherein the mixer is at least partially disposed within the receiving chamber and the air cap interfaces with the receiver at a locking interface to secure the mix chamber assembly to the receiver.

The receiver includes a second rotation lock configured to interface with the mixer to prevent rotation of the mixer about the axis.

The receiver includes a cap retainer disposed at a first end of the receiver, and wherein the locking interface is formed between the air cap and the cap retainer.

The locking interface is a threaded interface.

The receiver includes a mount body having a first flat lateral side and a second flat lateral side.

The receiver includes a tail disposed at a second axial end of the receiver, the second axial end of the receiver disposed at an axially opposite end of the receiver from the locking interface.

An air cap configured for use in a plural component sprayer includes a cap body disposed about a cap axis, the cap body having a first axial side facing in a first axial direction along the cap axis and a second axial side facing in a second axial direction along the cap axis, a mount extending in the second axial direction from the second axial side, the mount including first threading formed on one of an exterior radial surface of the mount and on an interior radial surface of the mount, and a cap bore extending through the air cap between the first axial side and the retainer face of the mount.

The air cap of the preceding paragraph can optionally include, additionally and/or alternatively, any one or more of the following features, configurations and/or additional components:

The first threading is formed on the interior radial surface.

The first threading is formed on the exterior radial surface.

The mount includes second threading formed on an opposite radial surface of the mount from the first threading.

The cap body is overmolded on a portion of the mount.

The mount includes a cap end that is at least partially disposed within the cap body and the mount includes a mount end that extends in the second axial direction from the second axial side.

A first annular projection extending in the second axial direction from the second axial side such that the mount is at least partially radially overlapped by the first annular projection.

The first annular projection is disposed at an outer radial edge of the cap body.

The first annular projection is spaced radially inward from an outer radial edge of the cap body.

At least one protrusion formed on the first annular projection, the at least one protrusion extending radially.

The at least one protrusion includes at least one cap tooth.

At least one protrusion includes a plurality of projections extending annularly about the cap axis.

Each projection of the plurality of projections includes a plurality of teeth.

The at least one protrusion is formed as an annular array of teeth.

A second annular projection extending in the second axial direction from the second axial side such that the mount is at least partially radially overlapped by the first annular projection.

An air cap configured for use in a plural component sprayer includes a cap body disposed about a cap axis, the cap body having a first axial side facing in a first axial direction along the cap axis and a second axial side facing in a second axial direction along the cap axis, a mount connected to the cap body. The mount includes a cap end at least partially disposed within the cap body and a mount end projecting axially outward from the second axial side of the cap body. The air cap configured for use in a plural component sprayer further includes a cap bore extending through the air cap between the first axial side and the retainer face of the mount.

The air cap of the preceding paragraph can optionally include, additionally and/or alternatively, any one or more of the following features, configurations and/or additional components:

The mount includes first threading formed on one of an exterior radial surface of the mount and on an interior radial surface of the mount.

The cap end is formed as an annular projection.

The cap end is formed as a radially-extending flange.

The cap body is overmolded on the cap end.

The cap body further includes: a first annular projection extending in the second axial direction from the second axial side such that the mount is at least partially radially overlapped by the first annular projection.

At least one protrusion formed on the first annular projection, the at least one protrusion extending radially.

The cap body further includes a second annular projection extending in the second axial direction from the second axial side such that the mount is at least partially radially overlapped by the first annular projection.

A mix assembly includes the air cap of any of the foregoing air caps configured for use in a plural component sprayer and a mixer having a mix bore extending axially into the mixer and having a first inlet bore extending to the mix bore and second inlet bore extending to the mix bore, the mixer extending into the cap bore and connected to the air cap.

The mixer is mountable to the air cap and dismountable from the air cap by a threaded interface between the first threading and the mixer.

A mixer configured to receive individual component materials that chemically interact to form a plural component material for spraying by a plural component sprayer includes a mix chamber body, a retaining head spaced from a first axial end of the mix chamber body such that an axial receiver is formed between the retaining head and the mix chamber body, and a seal head disposed at a second axial end of the mix chamber body opposite the first axial end, where the seal head has an exterior surface that converges towards the axis. The mixer can further include a first inlet bore extending through the mix chamber body to the mix bore, a second inlet bore extending through the mix chamber body to the mix bore, and an outlet orifice formed at a distal end of a mix bore, the mix bore extending along an axis through the mix chamber body, the mix bore intersecting with the first inlet bore and the second inlet bore, and the mix bore extending through the retaining head.

The mixer of the preceding paragraph can optionally include, additionally and/or alternatively, any one or more of the following features, configurations and/or additional components:

The exterior surface is conical about the axis.

The retaining head is formed on an axial projection extending from the first axial end.

The retaining head is disposed at a distal end of the axial projection, the distal end opposite a proximal end of axial projection, the proximal end interfacing with the mix chamber body.

The retaining head is spaced from a distal end of the axial projection, the distal end opposite a proximal end of axial projection, the proximal end interfacing with the mix chamber body.

The retaining head is formed by threading.

The retaining head is cantilevered from the mix chamber body.

The seal head is cantilevered from the mix chamber body.

The seal head includes a seal receiving groove formed in the exterior surface.

The seal receiving groove extends annularly about the axis.

The seal receiving groove includes an unobstructed seal path extending fully about the axis.

The seal receiving groove is formed as a plurality of discrete seal receiving grooves.

A chamber seal is mounted in the seal receiving groove.

The chamber seal extends fully about the axis and includes at least one orifice formed through the chamber seal.

The chamber seal includes two orifices therethrough, a first one of the two orifices aligned with the first inlet bore and a second one of the two orifices aligned with the second inlet bore.

The seal receiving groove includes a first wall having a first height from a base of the seal receiving groove and a second wall having a second height from the base of the seal receiving groove.

The first height is less than the second height.

The second wall is axially closer to the spray orifice than the first wall.

A first seal groove is formed in the mix chamber body and disposed on a first axial side of the seal head, and a second seal groove formed in the mix chamber body and disposed on a second axial side of the seal head.

The first seal groove extends fully about the axis and the second seal groove extends fully about the axis.

The seal head includes an axial rib projecting from the exterior surface.

The seal head includes an annular rib projecting from the exterior surface.

The first inlet bore and the second inlet bore extend through the seal head.

A mixer configured to receive individual component materials that chemically interact to form a plural component material for spraying by a plural component sprayer includes a mix chamber body extending between a first axial end and a second axial end opposite the first axial end, a seal head disposed at the second axial end of the mix chamber body, wherein the seal head has an exterior surface, and a first inlet bore extending through the seal head to the mix bore. The mixer can further include a second inlet bore extending through the seal head to the mix bore and an outlet orifice formed at a distal end of a mix bore, the mix bore extending along an axis through the mix chamber body, the mix bore intersecting with the first inlet bore and the second inlet bore, and the mix bore extending through the retaining head.

The mixer of the preceding paragraph can optionally include, additionally and/or alternatively, any one or more of the following features, configurations and/or additional components:

The seal head is integrally formed with the mix chamber body.

A seal groove extends annularly about the axis and is formed in the seal head.

A first axial rib projecting from the exterior surface.

A second axial rib projecting from the exterior surface.

A first annular rib projecting from the exterior surface.

A second annular rib projecting from the exterior surface.

The first axial rib is disposed on an opposite circumferential side of an inlet opening of the first inlet bore from the second axial rib.

The first axial rib is disposed on an opposite circumferential side of an inlet opening of the second inlet bore from the second axial rib.

The first annular rib is disposed on an opposite axial side of an inlet opening of the first inlet bore from the second annular rib.

The first annular rib is disposed on an opposite axial side of an inlet opening of the second inlet bore from the second annular rib.

The exterior surface converges towards the axis.

The exterior surface is conical.

A method includes aligning a mixer of a mix chamber assembly with a receiving chamber of a plural component sprayer along an axis, the mix chamber assembly further including an air cap connected to the mixer, shifting the mix chamber assembly in a first axial direction such that the mixer enters into the receiving chamber, and engaging a locking interface between the mix chamber assembly and the plural component sprayer to secure the mix chamber assembly to the plural component sprayer.

The method of the preceding paragraph can optionally include, additionally and/or alternatively, any one or more of the following features, configurations and/or additional components:

Engaging the locking interface between the mix chamber assembly and the plural component sprayer includes rotating the air cap of the mix chamber assembly about the axis.

Rotating the air cap of the mix chamber assembly about the axis engages a threaded interface between the air cap and the receiver.

Engaging the locking interface between the mix chamber assembly and the plural component sprayer includes preventing rotation of the mixer about the axis by an anti-rotation interface between the mixer and the receiver such that the air cap rotates relative to the mixer while the mixer is limited to axial movement by the anti-rotation interface.

Exerting an axial force on the mixer by the air cap to bias the mixer in the first axial direction and into the receiving chamber.

Engaging a protrusion extending from the air cap with a groove formed on the plural component sprayer to form a retaining interface therebetween, the retaining interface preventing rotation of the air cap about the axis with the mix chamber assembly mounted to the plural component sprayer.

A method of modifying a plural component sprayer includes manipulating a first air cap of a first mix chamber assembly to disengage a locking interface between the first air cap and the plural component sprayer, pulling the first air cap in a first axial direction along a spray axis of the plural component sprayer such that the first air cap engages a first mixer of the first mix chamber assembly and pulls the first mixer in the first axial direction and out from a receiving chamber of the plural component sprayer, and aligning a second mix chamber assembly with the receiving chamber along the spray axis. The method can further include shifting the second mix chamber assembly in a second axial direction opposite the first axial direction such that a second mixer of the second mix chamber assembly enters into the receiving chamber and manipulating a second air cap of the second mix chamber assembly to engage a locking interface between the second air cap and the plural component sprayer.

The method of the preceding paragraph can optionally include, additionally and/or alternatively, any one or more of the following features, configurations and/or additional components:

The second mixer is different than the first mixer.

The first mixer has a first pair of inlet bores having first diameters, the second mixer has a second pair of inlet bores having second diameters, and the second diameters are different from the first diameters.

Manipulating the first air cap of the first mix chamber assembly to disengage the locking interface between the first air cap and the plural component sprayer includes rotating the first air cap in a first rotational direction about the spray axis and manipulating the second air cap of the second mix chamber assembly to engage the locking interface between the second air cap and the plural component sprayer includes rotating the second air cap in a second rotational direction about the spray axis, the second rotational direction opposite the first rotational direction.

Rotating the first air cap and pulling the first air cap in the first axial direction includes a single twist and pull motion.

Shifting the second mix chamber assembly in the second axial direction and rotating the second air cap includes a single push and twist motion.

A mixer configured for a plural component sprayer includes a mix chamber body, a mix bore extending along an axis through the mix chamber body, wherein an outlet orifice is formed at a distal end of the mix bore, and a seal head disposed at a second axial end of the mixer opposite the first axial end, wherein the seal head has an exterior surface that converges towards the axis. The mixer can further include a first inlet bore extending through the seal head to the mix bore and a second inlet bore extending through the seal head to the mix bore.

The mixer of the preceding paragraph can optionally include, additionally and/or alternatively, any one or more of the following features, configurations and/or additional components:

A retaining head disposed at a first axial end of the mixer, the mix bore extending through the retaining head.

An opening of the first inlet bore is formed through the exterior surface that converges towards the axis, and an opening of the second inlet bore is formed through the exterior surface that converges towards the axis.

The exterior surface is conical.

The seal head is formed as a wedge shape and the exterior surface includes at least two exterior surfaces.

A seal groove is formed on the seal head, the seal groove extending into the exterior surface and configured to receive a chamber seal.

The seal groove extends annularly about the axis.

A first seal shoulder is formed at a first axial end of the seal groove and a second seal shoulder is formed at a second axial end of the seal groove, the second seal shoulder projecting further radially from a base of the seal groove than the first seal shoulder.

A first rotation lock is formed on the mix chamber body, the first rotation lock configured to interface with a second rotation lock of the plural component sprayer to prevent the mixer from rotating about the axis.

The first rotation lock is a projection extending outward from the mix chamber body.

A neck extending between and connecting the retaining head and the mix chamber body, the retaining head extending further from the axis than the neck.

The mix chamber body extends radially outward relative to the neck and the retaining head at an end of the neck opposite the retaining head.

The first inlet bore has a first diameter, the mix bore has a second diameter, and the second diameter is larger than the first diameter.

The retaining head includes exterior threading.

A first axial rib projecting from the exterior surface of the seal head and extending axially along the seal head, the first axial rib disposed circumferentially between the first inlet bore and the second inlet bore. The mixer can further include a second axial rib projecting from the exterior surface of the seal head and extending axially along the seal head, the first axial rib disposed circumferentially between the first inlet bore and the second inlet bore, the first axial rib is disposed on an opposite circumferential side of the first inlet bore from the second axial rib.

A first annular rib projecting from the exterior surface of the seal head and extending annularly about the seal head and a second annular rib projecting from the exterior surface of the seal head and extending annularly about the seal head, the second annular rib disposed on an opposite axial side of the first inlet bore from the first annular rib.

A first seal neck extending between the mix chamber body and a first axial end of the seal head, a second seal neck extending from a second axial end of the seal head opposite the first axial end of the seal head, a first seal recess formed annularly about the first seal neck and axially between the mix chamber body and the seal head, and a second seal recess formed annularly about the second seal neck and at least partially axially defined by the seal head.

A plural component sprayer configured to receive individual component materials that chemically interact to form a plural component material for spraying by the plural component sprayer includes a receiver disposed within a body of the plural component sprayer, a mixer at least partially disposed within the receiver, the mixer including a mix bore extending along an axis, a first inlet bore extending from an exterior of the mixer to the mix bore to provide a first individual component material to the mix bore, a second inlet bore extending from the exterior of the mixer to the mix bore to provide a second individual component material to the mix bore, and a spray orifice formed at an end of the mix bore and configured to emit the plural component material, and an air cap interfacing with the mixer to bias the mixer into the receiver.

The plural component sprayer of the preceding paragraph can optionally include, additionally and/or alternatively, any one or more of the following features, configurations and/or additional components:

The air cap is mounted to the plural component sprayer by a threaded interface.

The mixer includes a mix chamber body and an axial projection extending from the mix chamber body, the spray orifice formed at an end of the axial projection.

The air cap interfaces with the mix chamber body and the axial projection extends at least partially through the air cap.

The receiver includes a first feed bore aligned with the first inlet bore and a second feed bore aligned with the second inlet bore.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A mixer configured for a plural component sprayer, the mixer comprising:
a mix chamber body;
a mix bore extending along an axis through the mix chamber body, wherein an outlet orifice is formed at a distal end of the mix bore, the mix bore open through a first axial end of the mix chamber body, the mix bore open through a first axial end of the mix chamber body;
a first inlet bore extending through the mix chamber body to the mix bore;
a second inlet bore extending through the mix chamber body to the mix bore and
a seal head disposed at a second axial end of the mixer opposite the first axial end, wherein the seal head has an exterior surface that converges towards the axis.

2. The mixer of claim 1, wherein the first inlet bore and the second inlet bore extend through the seal head.

3. The mixer of claim 1, wherein the seal head is conical.

4. (canceled)

5. The mixer of claim 1, wherein a seal groove is formed on the seal head, the seal groove extending into the exterior surface and configured to receive a chamber seal.

6. The mixer of claim 5, wherein the seal groove extends annularly about the axis.

7. The mixer of claim 5, wherein a first seal shoulder is formed at a first axial end of the seal groove and a second seal shoulder is formed at a second axial end of the seal groove, the second seal shoulder projecting further radially from a base of the seal groove than the first seal shoulder.

8. The mixer of claim 1, further comprising:
a retaining head disposed at a first axial end of the mixer, the mix bore extending through the retaining head.

9. The mixer of claim 1, further comprising a projection extending outward from the mix chamber body, the projection configured to prevent rotation of the mixer about the axis.

10. The mixer of claim 8, further comprising:
a neck extending between and connecting the retaining head and the mix chamber body, the retaining head extending further outward from the axis than the neck.

11. The mixer of claim 10, wherein the mix chamber body extends radially outward relative to the neck and the retaining head at an end of the neck opposite the retaining head.

12. The mixer of claim 1, wherein the first inlet bore has a first diameter, the mix bore has a second diameter, and the second diameter is larger than the first diameter.

13. The mixer of claim 8, wherein the retaining head includes exterior threading.

14. (canceled)

15. (canceled)

16. (canceled)

17. A mix chamber assembly for use in a plural component sprayer, the mix chamber assembly comprising:
an air cap having a central opening therethrough;
a mixer mounted to the air cap and at least partially disposed within the central opening, wherein the mixer comprises:
a mix chamber body;
a mix bore extending along an axis through the mix chamber body, wherein an outlet orifice is formed at a distal end of the mix bore;
a first inlet bore extending through the mix chamber body to the mix bore; and
a second inlet bore extending through the mix chamber body to the mix bore.

18. (canceled)

19. (canceled)

20. The mix chamber assembly of claim 17, wherein the mixer further comprises:
a neck extending from a first axial end of the mix chamber body; and
a retaining head disposed at an end of the neck such that the neck extends between and connects the retaining head and the mix chamber body;
wherein the mix bore extends through the neck and the retaining head; and
wherein an annular recess is formed about the neck and axially between the retaining head and the mix chamber body.

21. The mix chamber assembly of claim 20, wherein the retaining head includes first threads and the air cap includes second threads formed in the central opening.

22. The mix chamber assembly claim 20, wherein the air cap includes a mount extension at least partially disposed within the annular recess.

23. The mix chamber assembly of claim 22, wherein the retaining head is sized such that an interface between the retaining head and the mount extension prevents the mount extension from passing axially over the retaining head and out of the annular recess in an axial direction away from the mix chamber body.

24. The mix chamber assembly of claim 22, wherein the air cap is rotatable about the axis and relative to the mixer with the mount extension disposed in the annular recess.

25. The mix chamber assembly of claim 17, wherein a second axial end of the mix chamber body is contoured such that at least one surface of the mix chamber body is angled towards the axis.

26. (canceled)

27. (canceled)

28. The mix chamber assembly of claim 25, wherein a chamber seal is disposed on the at least one surface.

29-139. (canceled)
